(19) United States
(12) Patent Application Publication
(10) Pub. No.: US 2011/0258015 A1
(43) Pub. Date: Oct. 20, 2011

(54) SYSTEM FOR PROVIDING WORKFORCE PLANNING SERVICES

(75) Inventors: Heide Garrigan, Centennial, CO (US); W. Christopher Draper, JR., Califon, NJ (US); John R. Hubbell, Swarthmore, PA (US); Jill K. Goldstein, Fort Lauderdale, FL (US); Henry G. Moody, Centennial, CO (US); Mark P. Nynka, Succasunna, NJ (US); Peggy L. Roos, Minneapolis, MN (US); W. Mark Allen, Millburn, NJ (US)

(73) Assignee: ACCENTURE GLOBAL SERVICES GMBH, Schaffhausen (CH)

(21) Appl. No.: 12/763,447

(22) Filed: Apr. 20, 2010

(51) Int. Cl. G06Q 10/00

(52) U.S. Cl. 705/7.25; 705/321

(57) ABSTRACT

A system is described for providing workforce planning services. The system may include a memory, an interface, and a processor. The memory may store a baseline dataset describing current employees of an organization. The processor may be operative to determine a projected workforce dataset based on the baseline dataset, the projected workforce dataset describing projected employees required by the organization. The processor may assess the baseline dataset and employee movement strategies to determine a forecasted available workforce dataset describing forecasted employees available to the organization. The processor may determine a gap between the projected workforce dataset and the forecasted available workforce dataset. The processor may generate a workforce service plan which describes strategies for eliminating the gap and may provide the plan to a user. The processor may receive updates to the baseline dataset and may assess the updates to determine whether the plan is being effectively implemented.

### TECHNICAL FIELD

The present description relates generally to a system and method, generally referred to as a system, for providing workforce planning services, and more particularly, but not exclusively, to providing an organization with workforce action plans for accomplishing/supporting strategic business objectives and monitoring the organization's progress towards accomplishing the strategic business objectives through the action plans.

### BACKGROUND

Human capital may be a major source of competitive advantage for organizations. For example, studies may have shown that human capital is the most important factor for maintaining an organization's competitive advantage in the marketplace over the long term. Thus, it may be important for an organization to effectively manage its workforces to ensure their human capital is sustained over. However, a convergence of recent factors, such as expected employee exoduses due to baby boomer retirements and labor pool shrinkage due to low birth rates, may be rendering traditional systems ineffective for managing workforces within an organization.

### SUMMARY

A system for providing workforce planning services may include a memory, an interface, and a processor. The memory may be connected to the processor and the interface and may store a baseline workforce dataset describing a current plurality of employees of an organization. The interface may be coupled to the memory and may be operative to communicate with a device of a user. The processor may be coupled to the memory and the interface and may be operative to identify the baseline workforce dataset. The processor may determine a projected workforce dataset based on the baseline workforce dataset. The projected workforce dataset may describe a projected plurality of employees required by the organization over a period of time. The processor may assess the baseline workforce dataset and employee movement strategies to determine a forecasted available workforce dataset. The forecasted available workforce dataset may describe a forecasted plurality of employees available to the organization over the period of time. The processor may determine a workforce gap dataset which describes a gap between the projected workforce dataset and the forecasted available workforce dataset. The processor may generate a workforce service plan which describes strategies for eliminating the gap described by the workforce gap dataset over the period of time. The processor may provide, via the interface, the workforce service plan to the device of the user. The processor may receive, via the interface, updates to the baseline workforce dataset over the period of time. The processor may assess the updates to the baseline workforce dataset to determine whether the workforce service plan is being effectively implemented.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a system for providing workforce planning services.

FIG. 2 is a block diagram of a network environment implementing the system of FIG. 1 or other systems for providing workforce planning services.

FIG. 3 is a flowchart illustrating the generation of a workforce action plan in the system of FIG. 1 or other systems for providing workforce planning services.

FIG. 4 is a flowchart illustrating workforce action plan generation and monitoring in the system of FIG. 1, or other systems for providing workforce planning services.

FIG. 5 is a flowchart illustrating the generation of a workforce action plan to support a business strategy in the system of FIG. 1, or other systems for providing workforce planning services.

FIG. 6 is a flowchart illustrating workforce planning services in the system of FIG. 1, or other systems for providing workforce planning services.

FIG. 7 is a flowchart illustrating the management of metrics in the system of FIG. 1, or other systems for providing workforce planning services.

FIG. 8 is a flowchart illustrating the attainment of corporate objectives in the system of FIG. 1, or other systems for providing workforce planning services.

FIG. 9 is a flowchart illustrating the management of workforce risks in the system of FIG. 1, or other systems for providing workforce planning services.

FIG. 10 is a flowchart illustrating the management of workforce initiatives in the system of FIG. 1, or other systems for providing workforce planning services.

FIG. 11 is a flowchart illustrating the creation of an annual plan in the system of FIG. 1, or other systems for providing workforce planning services.

FIG. 12 is a flowchart illustrating an alternative creation of an annual plan in the system of FIG. 1, or other systems for providing workforce planning services.

FIG. 13 is a flowchart illustrating progress monitoring in the system of FIG. 1, or other systems for providing workforce planning services.

FIG. 14 is a screenshot of an annual plan in the system of FIG. 1, or other systems for providing workforce planning services.

FIG. 15 is a screenshot of a strategic plan workbook in the system of FIG. 1, or other systems for providing workforce planning services.

FIG. 16 is a screenshot of a business objectives table in the system of FIG. 1, or other systems for providing workforce planning services.

FIG. 17 is a screenshot of a goals and strategies display in the system of FIG. 1, or other systems for providing workforce planning services.

FIG. 18 is a screenshot of an annual goals display in the system of FIG. 1, or other systems for providing workforce planning services.

FIG. 19 is a screenshot of a strategic timeline in the system of FIG. 1, or other systems for providing workforce planning services.

FIG. 20 is a screenshot of financial plan information in the system of FIG. 1, or other systems for providing workforce planning services.

FIG. 21 is a screenshot of additional financial plan information in the system of FIG. 1, or other systems for providing workforce planning services.

FIG. 22 is a screenshot of a 90-day plan in the system of FIG. 1, or other systems for providing workforce planning services.

FIG. 23 is a screenshot of text options in the system of FIG. 1, or other systems for providing workforce planning services.

FIG. 24 is a screenshot of a talent planning service workflow in the system of FIG. 1, or other systems for providing workforce planning services.

FIG. 25 is a screenshot of a talent planning deliverables workflow in the system of FIG. 1, or other systems for providing workforce planning services.

FIG. 26 is a screenshot of an alternative talent planning deliverables workflow in the system of FIG. 1, or other systems for providing workforce planning services.

FIG. 27 is a block diagram illustrating a talent planning personnel hierarchy in the system of FIG. 1, or other systems for providing workforce planning services.

FIG. 28 is an illustration of a general computer system that may be used in the systems of FIG. 2, or other systems for providing workforce planning services.

### DETAILED DESCRIPTION

A system and method, generally referred to as a system, may relate to providing workforce planning services, and more particularly, but not exclusively, to providing an organization with workforce action plans for accomplishing/supporting strategic business objectives and monitoring the organization's progress towards accomplishing the strategic business objectives through the action plans. The principles described herein may be embodied in many different forms.

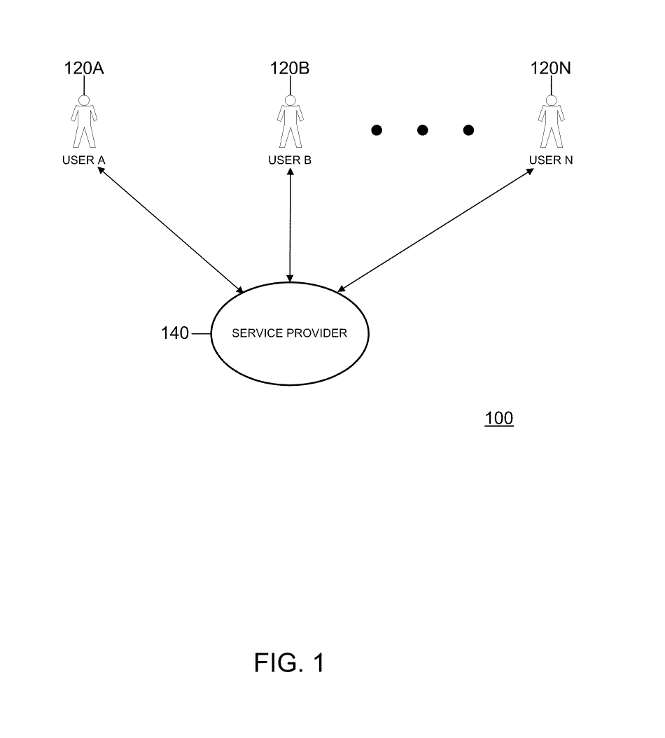

FIG. 1 provides a general overview of a system 100 for providing a workforce planning services. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more users 120A-N, an administrator 110, and a service provider 140. The users 120A-N may be employees of an organization who are responsible for making decisions regarding the organization's hiring and staffing needs. Alternatively, the users 120A-N may be one or more consultants who are providing consulting services to the organization, such as human resource consultants. The structure of the organization may include one or more business units or functional units. Each business unit and functional unit may include multiple families of jobs, or job families, which may be spread across multiple geographic regions. In the system 100, a job may be a particular set of responsibilities, work activities and underlying skills, and a business function may be a conceptual grouping of jobs that have similar skills, requirements and related career paths. Each job may be associated with one or more job levels which may distinguish varying levels of skill within the job.

The service provider 140 may provide the users 120A-N with workforce planning services through one or more software applications, such as through a spreadsheet or a web-accessible application. The workforce planning services may allow the users 120A-N to effectively forecast and manage employee staffing needs over a period of time, such as one year, three years, or five years. The workforce planning services may also allow the users 120A-N to identify business objectives and ensure the workforce includes a sufficient number of employees skilled in the competencies required to accomplish the business objectives. The service provider 140 may receive and store a baseline workforce dataset which may describe the current employees in the workforce and the competencies they may have. The service provider 140 may identify a business objective and may determine the competencies required to achieve the business objective. The service provider 140 may determine a forecasted number of employees with the determined competencies required to achieve the business objective over a period of time. The service provider 140 may also determine an available number of employees with the determined competencies over the period of time. The available number of employees may be based on one or more factors, such as expected retirements, expected terminations, expected growth, etc. If the forecasted number of employees is less than the number of employees expected to be available, the service provider 140 may generate one or more action plans for ensuring the forecasted required number of employees are available and the business objective is accomplished. The service provider 140 may monitor the progress of implementing the action plans and accomplishing the business objectives.

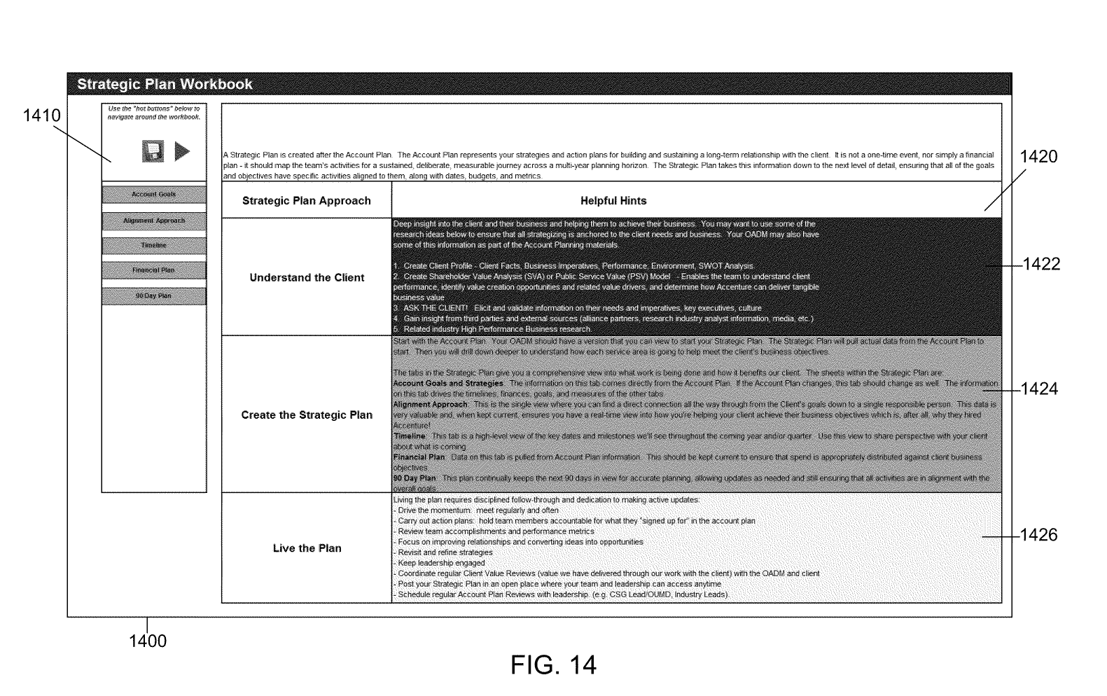

The service provider 140 may transform the action plans into a workforce annual plan and may provide the annual plan to the user A 120A. The workforce annual plan may include one or more of the action plans generated by the service provider 140, such as a talent acquisition plan, a talent development plan, a talent retention plan, or other action plans related to the workforce. For example, the provide the user A 120A with one or more interactive user interfaces for viewing the annual plan, such as the interfaces in FIGS. 14-22 below. The user A 120A may use the user interfaces to view, confirm, and/or modify the action plans.

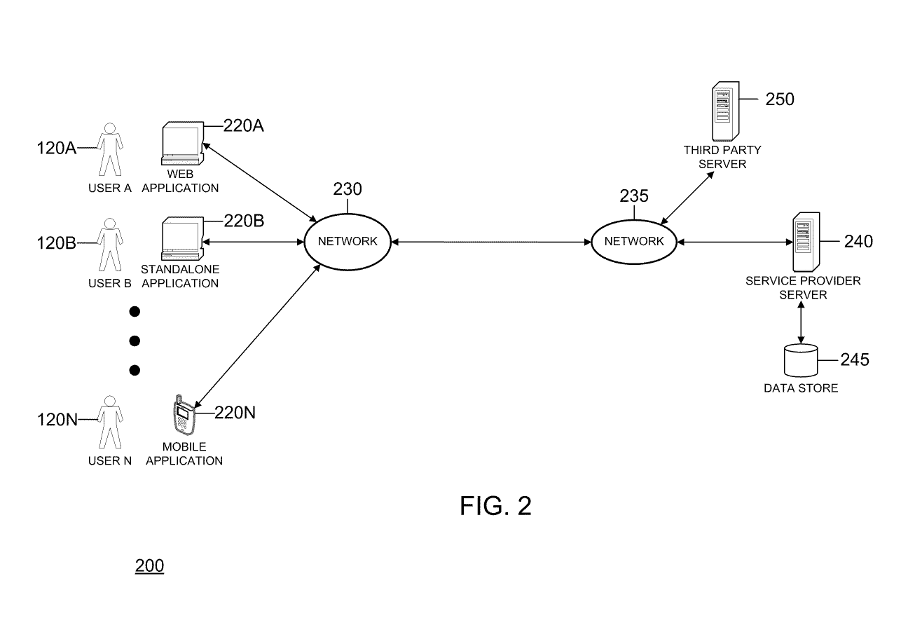

FIG. 2 provides a simplified view of a network environment 200 implementing the system of FIG. 1 or other systems for providing a workforce planning tool. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more users 120A-N, a service provider server 240, a third party server 250, a data store 245, networks 230, 235, and one or more web applications, standalone applications, mobile applications 220A-N, which may collectively be referred to as client devices 220A-N. Some or all of the service provider server 240 and the third party server 250 may be in communication with each other by way of network 235.

The networks 230, 235 may include wide area networks (WAN), such as the Internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet, or the like.

The web applications, standalone applications and mobile applications 220A-N may be connected to the network 230 in any configuration that supports data transfer. This may include a data connection to the network 230 that may be wired or wireless. Any of the web applications, standalone applications and mobile applications 220A-N may individually be referred to as a client application. The web application 220A may run on any platform that supports web content, such as a web browser or a computer, a mobile phone, personal digital assistant (PDA), pager, network-enabled television, digital video recorder, such as TIVO®, automobile and/or any appliance or platform capable of data communications. The web application 220A may support a rich internet application implemented with the ADOBE FLEX® technologies. Alternatively or in addition the web application 220A may be developed using one or more of the following technologies: ADOBE FLEXBUILDER 3®, ADOBE FLEX SUBCLIPSE®, or generally any web development technologies.

The standalone application 220B may run on a machine that may have a processor, memory, a display, a user interface and a communication interface. The processor may be operatively connected to the memory, display and the interfaces and may perform tasks at the request of the standalone application 220B or the underlying operating system. The memory may be capable of storing data. The display may be operatively connected to the memory and the processor and may be capable of displaying information to the user B 120B. The user interface may be operatively connected to the memory, the processor, and the display and may be capable of interacting with a user B 120B. The communication interface may be operatively connected to the memory, and the processor, and may be capable of communicating through the networks 230, 235 with the service provider server 240. The standalone application 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX®, amongst others.

The mobile application 220N may run on any mobile device that may have a data connection. The data connection may be a cellular connection, a wireless data connection, an internet connection, an infra-red connection, a Bluetooth connection, or any other connection capable of transmitting data. For example, the mobile application 220N may be an application running on an APPLE IPHONE®.

The service provider server 240 may include one or more of the following: an application server, a mobile application server, a data store, a database server, and a middleware server. The service provider server 240 may exist on one machine or may be running in a distributed configuration on one or more machines.

The service provider server 240 and client applications 220A-N may be one or more computing devices of various kinds, such as the computing device in FIG. 28. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web application 220A may employ the Hypertext Transfer Protocol (“HTTP”) to request information, such as a web page, from a web server, which may be a process executing on the service provider server 240.

There may be several configurations of database servers, application servers, mobile application servers, and middleware applications included in the service provider server 240. The data store 245 may be part of the service provider server 240 and may be a database server, such as MICROSOFT SQL SERVER®, ORACLE®, IBM DB2®, SQLITE®, or any other database software, relational or otherwise. The application server may be APACHE TOMCAT®, MICROSOFT IIS®, ADOBE COLDFUSION®, or any other application server that supports communication protocols.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In operation, the user A 120A may access the service provided by the service provider server 240 through the web application 220A and the network 230. The user A 120A may interact with the service provider server 240 through the web application 220A. The data may be passed between the web application 220A and the database 245. The majority of the calculations may be performed on the service provider server 240, although some calculations may be completed on the web application 220A in order to speed up response times.

Alternatively or in addition, the users 120A-N may access the system 100 through a spreadsheet, such as a MICROSOFT EXCEL® spreadsheet. In this case, an application for accessing the spreadsheet, such as MICROSOFT EXCEL®, may be running on the service provider server 240. The users 120A-N may access the application directly through an interface connected to the service provider server 240, such as a keyboard and/or a pointing device.

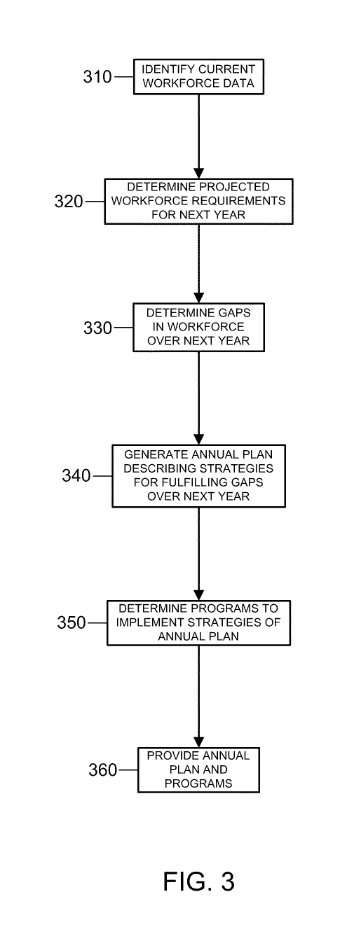

FIG. 3 is a flowchart illustrating the generation of a workforce action plan in the system of FIG. 1 or other systems for providing workforce planning services. The steps of FIG. 3 are described as being performed by the service provider server 240. However, the steps may be performed by the processor of the service provider server 240, or by any other hardware component of the service provider server 240. Alternatively the steps may be performed by an external hardware component, such as a computer operated by one of the users 120A-N in communication with the service provider server 240.

At step 310, the service provider server 240 may identify a baseline workforce dataset of an organization. For example, the service provider server 240 may provide a user interface to the user A 120A, and the user A 120A may input the workforce dataset of the organization. The workforce dataset may describe one or more workforce segments of the workforce. Each workforce segment may include a number of employees and each employee may have one or more competencies. At step 320, the service provider 240 may receive strategic business objectives. The strategic business objectives may be business objectives of the organization which rely on employees having certain competencies in the workforce segments.

At step 330, the service provider server 240 may select one or more competencies of the employees which are required to achieve the strategic business objectives. For example, the service provider server 240 may analyze the strategic business objectives and may determine the competencies required to achieve the strategic business objectives. Alternatively, or in addition, the service provider 240 may receive a selection of required competencies from one of the users 120A-N, such as through a user interface.

At step 340, the service provider server 240 may rank the workforce segments based on the number of employees within each workforce segment having the competencies required to achieve the strategic business objectives. The highest ranked workforce segment may be the workforce segment having the most number of employees with the determined competencies, and therefore may be the most valuable business segment in terms of achieving the strategic business objectives.

At step 350, the service provider server 240 may determine any workforce gap in the highest ranked business segment. The service provider server 240 may determine a workforce demand in the highest ranked business segment, which may indicate the number of employees needed in the workforce over a period of time to achieve the strategic business objectives. For example, the workforce demand may be determined based on one or more external market conditions, or growth factors. The service provider server 240 may also determine a workforce supply of the highest ranked workforce segment, which may indicate the forecasted supply of available employees with the determined competencies over the period of time. The service provider server 240 may determine a gap in the highest ranked workforce segment by comparing the workforce supply with the workforce demand.

At step 360, the service provider server 240 may generate an action plan for fulfilling the gap over the period of time. If the gap is a workforce shortage, the action plan may provide strategies for fulfilling the shortage, such as by external hiring, internal transfers, or internal training. If the gap is a workforce surplus, the action plan may provide strategies for eliminating the surplus, such as by terminations, retirements, or internal transfers. The action plan may include one or more of a talent acquisition plan, a talent development plan, or a talent retention plan. The talent acquisition plan may include a comparison of the forecasted workforce demand with the baseline workforce dataset. The talent development plan may describe a workforce shortage for each job family in the baseline workforce dataset over the period of time. The talent development plan may also describe a workforce shortage for each geographical area of the organization over the period of time. The talent retention plan may include a comparison of the forecasted workforce demand against retirement patterns, termination patterns and transfer patterns.

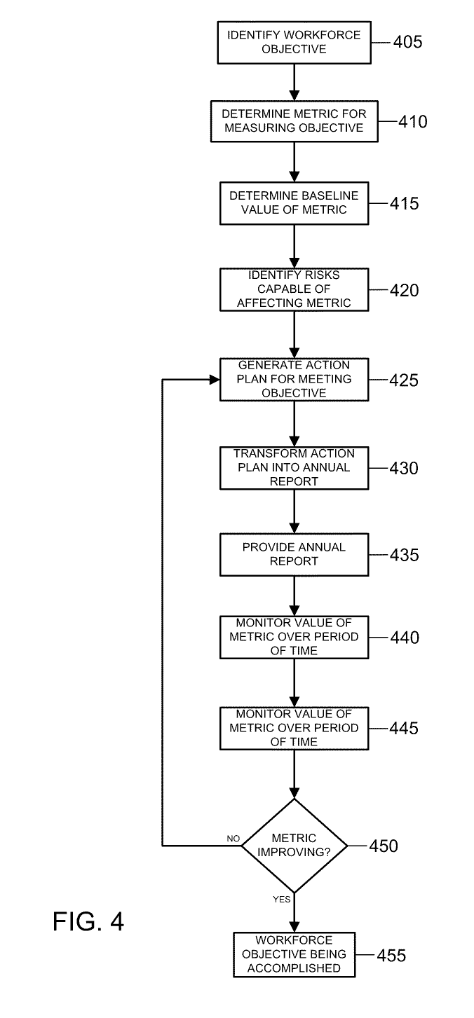

At step 370, the service provider server 240 may provide the action plan to one of the users 120A-N, such as through a user interface. For example, the service provider server 240 may transform the action plan into an annual report and may provide the annual report to the users 120A-N through the user interfaces described in FIGS. 14-22 below. At step 380, the service provider server 240 may monitor the implementation, and progress of the action plan. For example, the service provider server 240 may receive periodic updates to the baseline workforce dataset, such as daily updates, weekly updates, monthly updates, or generally any periodic, or aperiodic, updates. The updates may describe changes in the number of employees in each of the workforce segments. The service provider server 240 may update the baseline workforce dataset with the updates to create an updated workforce dataset. The service provider server 240 may compare the updated workforce dataset to the baseline workforce dataset to monitor the progress and implementation of the action plan. Monitoring the progress and implementation of the action plan is discussed in more detail in FIG. 4 below.

FIG. 4 is a flowchart illustrating workforce action plan generation and monitoring in the system of FIG. 1, or other systems for providing workforce planning services. The steps of FIG. 4 are described as being performed by the service provider server 240. However, the steps may be performed by the processor of the service provider server 240, or by any other hardware component of the service provider server 240. Alternatively the steps may be performed by an external hardware component, such as a computer operated by one of the users 120A-N in communication with the service provider server 240.

At step 410, the service provider server 240 may identify a baseline workforce dataset. For example, one of the users 120A-N may provide a baseline workforce dataset to the service provider server 240. The baseline workforce dataset may describe the current configuration of employees in the organization. The configuration may include business units, job families, geographic areas, or generally any data describing the organization. At step 420, the service provider server 240 may determine a projected workforce dataset based on the baseline workforce dataset and a criterion. The projected workforce dataset may describe the projected number of employees required by the organization over a period of time, such as one year, two years, etc. The projected workforce dataset may include job families, business units, geographic areas, or generally any information used to describe the organization in the baseline workforce dataset. The criterion may include any factors capable of affecting the number of employees required by the organization, such as an external market condition or a growth factor.

At step 430, the service provider server 240 may determine a forecasted available workforce dataset. The forecasted available workforce dataset may describe the number of employees currently forecasted to be available to the organization over the period of time. The forecasted available workforce dataset may be determined by assessing the baseline workforce dataset along with employee movement strategies and patterns, such as through terminations, retirements, internal transfers, etc.

At step 440, the service provider server 240 may determine a workforce shortage which describes a gap between the projected required workforce and the forecasted available workforce. At step 450, the service provider server 240 may generate a workforce service plan which describes one or more workforce strategies for eliminating the gap determined in step 440. The workforce service plan may describe one or more strategies for retaining employees, internally developing employees, and/or acquiring additional employees. At step 460, the service provider server 240 may provide the workforce service plan to the users 120A-N. For example, the service provider server 240 may transform the workforce service plan into an annual report which describes the strategies suggested for the upcoming year to eliminate the gap. The service provider server 240 may provide the annual report to the users 120A-N through one or more user interfaces, such as the user interfaces described in FIGS. 14-22 below.

At step 470, the service provider server 240 may receive updates to the baseline workforce dataset. The service provider server 240 may receive periodic updates to the baseline workforce dataset, such as daily updates, weekly updates, monthly updates, or generally any periodic, or aperiodic, updates. The updates may describe changes in the number of employees in the workforce. For example, the service provider server 240 may receive periodic data feeds from a human resources system which indicates the movement of employees into and out of the organization. Alternatively, or in addition, the service provider server 240 may provide a user interface to the users 120A-N for providing updates to the baseline workforce dataset. The users 120A-N may use the user interface to provide updated workforce information to the service provider server 240.

At step 480, the service provider server 240 may assess the updates to the baseline workforce dataset to determine whether the action plan is being effectively implemented by the users 120A-N and/or the organization. For example, the action plan may include one or more incremental goals to be accomplished over the period of time, such as hiring a certain number of employees, retaining a certain number of employees, or developing/training a certain number of employees. The service provider server 240 may monitor the updates to the workforce data to determine whether the incremental goals are being accomplished over the period of time.

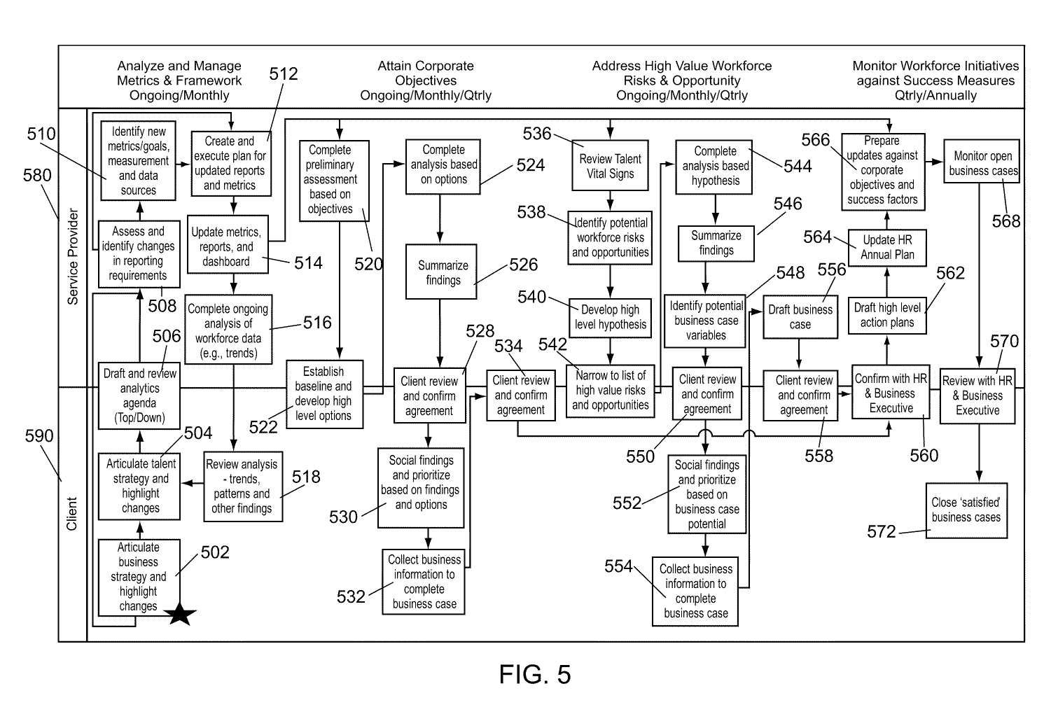

FIG. 5 is a flowchart illustrating the generation of a workforce action plan to support a business strategy in the system of FIG. 1, or other systems for providing workforce planning services. The steps of FIG. 5 are described as being performed by the service provider server 240. However, the steps may be performed by the processor of the service provider server 240, or by any other hardware component of the service provider server 240. Alternatively the steps may be performed by an external hardware component, such as a computer operated by one of the users 120A-N in communication with the service provider server 240.

At step 510, the service provider server 240 may identify a business strategy of an organization. The business strategy may include one or more business objectives of the organization. For example, the service provider server 240 may provide a user interface to the users 120A-N for identifying a business strategy of the organization. Alternatively, or in addition, the service provider server 240 may analyze historical business and/or workforce data of the organization to identify one or more areas where the business and/or workforce of the organization may be improved. The service provider server 240 may then identify one or more strategies for implementing the improvements. For example, if the service provider server 240 identifies that the organization can improve their business by entering into a new market, the service provider server 240, the business objective may be for the organization to enter into the new market.

At step 520, the service provider server 240 may identify a business metric capable of identifying whether the business objectives are being accomplished. For example, if the business objective is to enter into a new market, the business metric may be a number of sales achieved in the new market, or additional revenues obtained through the new market. At step 530, the service provider server 240 may identify a key workforce segment in the organization. The key workforce segment may be the workforce segment having the greatest affect on the business metric, and therefore the workforce segment which adds the most value to the business objective. For example, if the business objective is to enter a new market, the key workforce segment may be the workforce segment most closely aligned with the new market, such as geographically, functionally, or otherwise.

At step 540, the service provider server 240 determines the roles of employees within the key workforce segment required to achieve the business objective. At step 550, the service provider server 240 may rank the determined roles based on the affect each role has on the business metric and the number of employees having each role. For example, the service provider server 240 may determine a percentage of contribution each role has towards affecting the business metric. The service provider server 240 may then rank the roles by multiplying the percentage of contribution of each role by the number of employees within each role.

At step 560, the service provider server 240 may determine a forecasted number of employees required within each role over a period of time to accomplish the business objective. For example, if the business objective is to enter into a new market, the service provider server 240 may determine the number of employees within each role required to enter the new market over the period of time. The forecasted number of employees may account for external market factors, growth factors, etc. At step 570, the service provider server 240 may generate a workforce action plan for obtaining the forecasted number of employees required within each role. The workforce action plan may prioritize the acquisition of the highest ranked roles over the lower ranked roles. Thus, the workforce action plan may attempt to expend organizational resources towards obtaining employees contributing the most value to the business metric first, and then obtaining the employees contributing less value to the business metric.

At step 580, the service provider server 240 may implement the workforce action plan. For example, the service provider server 240 may provide the workforce action plan to the users 120A-N for implementing, such as through the user interfaces described in FIGS. 14-22 below. Alternatively, or in addition, the service provider server 240 may send notifications to one or more of the users 120A-N, such as through voicemails, emails, text messages or generally any notifications. The notifications may include instructions for implementing the workforce action plan.

At step 590, the service provider server 240 may monitor the implementation of the workforce action plan and/or the business metric, to determine whether the business objectives are being achieved over the period of time. For example, the service provider server 240 may monitor the workforce action plan to ensure it is being implemented properly and the service provider server 240 may monitor the business metric to ensure the workforce action plan is having the intended effect on the business metric. If the service provider server 240 determines that the workforce action plan is not having the intended effect on the business metric, the service provider server 240 may notify one of the users 120A-N that the workforce action plan may need to be modified. Alternatively, or in addition, the service provider server 240 may automatically modify the workforce service plan upon determining that the workforce service plan is not having the intended effect on the business metric.

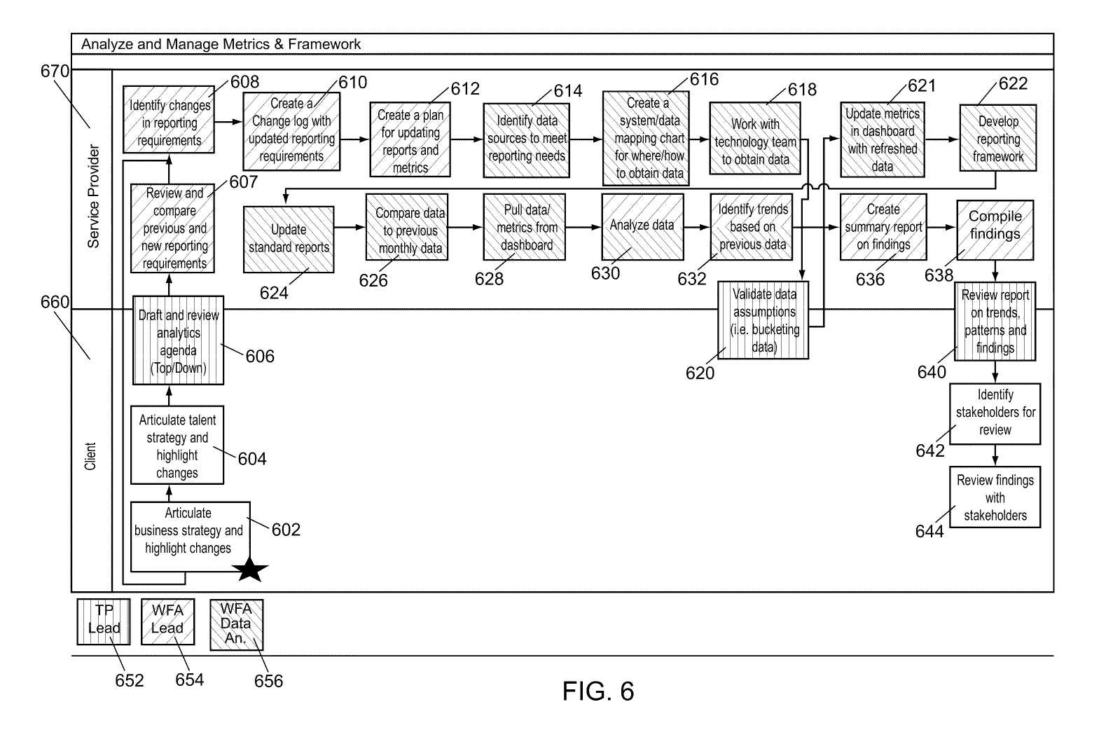

FIG. 6 is a flowchart illustrating workforce analytics services in the system of FIG. 1, or other systems for providing workforce analytics services. The steps of the flowchart in FIG. 6 may be associated with users 120A-N on a client team 690, such as users 120A-N employed by the organization, and/or users on a service provider team 680. The steps of FIG. 6 are described as being performed by, or accessed through, the service provider server 240 and/or the client devices 220A-N. For example, the service provider team 680 and/or the client team 690 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 602, the client team 690 identifies a business strategy and highlights any changes in the business strategy, such as through a graphical user interface provided by the service provider server 240. At step 604, the client team 690 identifies a talent strategy related to the business strategy, and highlights changes in the talent strategy, such as through a graphical user interface provided by the service provider server 240. At step 606, the service provider team 680, in partnership with the client team 690, generates an analytics agenda related to the business strategy and the talent strategy, such as through an application running on the service provider server 240. At step 608, service provider team 680 identifies changes in reporting requirements, if any, such as through a graphical user interface provided by the service provider server 240. At step 610, the service provider team 690 identifies new metrics/goals and data sources related to the metrics/goals, such as through a graphical user interface provided by the service provider server 240. At step 612, the service provider server 240 generates a plan for providing the updated reports and metrics and provides the plan to the service provider team 680, such as through a graphical user interface. At step 614, the service provider team 680 updates the metrics, the reports and a dashboard through a graphical user interface provided by the service provider server 240. At step 616, the service provider team 680 performs an analysis of workforce data describing the workforce of the organization, such as through a graphical user interface provided by the service provider server 240. At step 618, the service provider team 680 performs a review of trends, patterns and other findings affecting the workforce data.

At step 620, the service provider team 680 performs a preliminary assessment of the workforce data based on the objectives. At step 622, the service provider server 240 determines a baseline for the metrics and determines the high values for the metrics and/or the low values for the metrics and provides the baseline and high/low values to the service provider team 680. At step 624, the service provider server 240 performs an analysis based on the high level values. At step 626, the service provider server 240 generates a report of the findings. At step 628, the service provider server 240 provides the report to one of the users 120A-N for review, such as through one of the user interfaces described in FIGS. 14-22 below. At step 630, the service provider server 240 prioritizes the findings, such as based on the value provided by each finding. At step 632, the service provider server 240 receives business information collected by the client team 690 representative through financial and other corporate tools, systems or resources. At step 634, the service provider 240 provides the business information to the service provider team 680 and the client team 690, and provides a graphical user interface which allows the teams 680, 690 to confirm or edit the business information. At step 636, the service provider team 680 analyzes the talent vital signs, such as critical profile metrics related to the workforce. At step 638, the service provider team 680, through the service provider server 240, identifies potential risks and opportunities, which may affect the workforce data, such as external conditions. At step 640, the service provider team 680 generates a high level hypothesis on the workforce data, such as through the service provider server 240. At step 642, the service provider server 240 generates a list of high value risks and opportunities and provides the list to the service provider team 680.

At step 644, the service provider server 240 generates an analysis based on the determined hypothesis and provides the analysis to the service provider team 680. At step 646, the service provider server 240 generates a summary of the findings and provides the summary to the service provider team 680. At step 648, the service provider server team 680 identifies potential business case variables, such as through the service provider server 240. At step 650, the service provider server 240 provides the business case variables to one, or both, of the service provider team 680 and the client team 690. The teams 680, 690 may be able to review and/or edit the business case variables, such as through a graphical user interface provided by the service provider server 240. At step 652, the client team 690 prioritizes the findings based on business case potential. At step 654, the client team 690 identifies business information required to complete the business case. For example, the client team 690 may provide the business information to the service provider server 240 required to complete the business case. At step 656, the service provider server 240 generates a business case. At steps 658-660, the service provider server 240 provides the business case to one or both of the team 680, 690. The teams 680, 690 may review and/or edit the business case, such as through a graphical user interface provided by the service provider server 240. At step 662, the service provider server team 680, through the service provider server 240, generates one or more high level action plans for accomplishing the identified business strategies and/or objectives. At step 664, the service provider server 240 incorporates the high level action plans into the annual plan. At step 666, the service provider team 680 updates against corporate objectives and success factors, such as through a graphical user interface provided by the service provider server 240.

At step 668, the service provider server 240 may monitor open business cases. At step 670, the service provider server 240 may provide information regarding the open business cases to one or both of the teams 680, 690, such as through one of the user interfaces described in FIGS. 14-22 below. At step 572, the service provider server 240 notifies one of the users 120A-N of business cases which have been completed. The completed business cases may be closed by the users 120A-N.

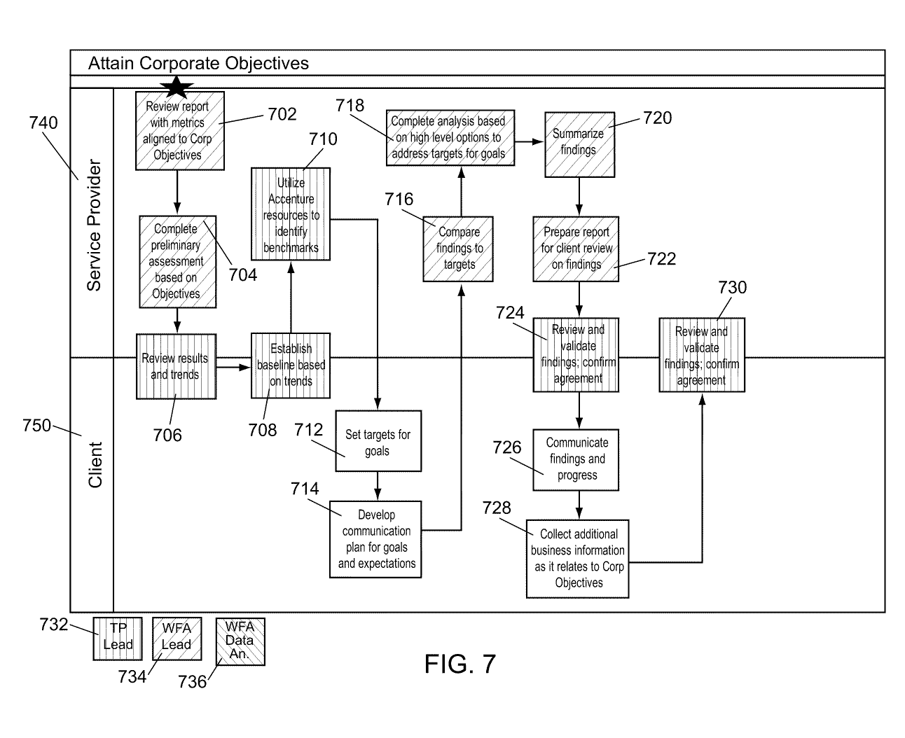

FIG. 7 is a flowchart illustrating the management of metrics in the system of FIG. 1, or other systems for providing workforce analytics services. The steps of the flowchart in FIG. 7 may be associated with users 120A-N on a client team 760, such as users 120A-N employed by the organization, and/or users on a service provider team 770, such as a Talent Planning lead 752, a Workforce Analytics lead 754, or a Workforce Analytics Data Analyst 756. The steps of FIG. 7 are described as being performed by, or accessed through, the service provider server 240 and/or the client devices 220A-N. For example, the service provider team 770 and/or the client team 760 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 702, the client team 760 identifies a business strategy and identifies changes in the business strategy, if any, such as through a graphical user interface provided by the service provider server 240. At step 704, client team 760 determines talent strategy and identifies changes in the talent strategy, if any, such as through a graphical user interface provided by the service provider server 240. At step 706, the service provider and client teams 760, 770 generate an analytics agenda through the service provider server 240, such as based on the business strategy and/or the talent strategy. At step 707, the service provider team 770 compares previous reporting requirements and new reporting requirements, such as through the service provider server 240. At step 708, the service provider team 770 determines changes in reporting requirements, if any. At step 710, the service provider server 240 generates a change log which stores updated reporting requirements. At step 712, the service provider server 240 generates a plan for updating reports and metrics. At step 714, the service provider server team 770 identifies data sources required to meet the reporting needs, such as through a graphical user interface provided by the service provider server 240. At step 716, the service provider server team 770 generates a system/data mapping chart through the service provider server 240 which displays where data is obtained, such as from which of the data sources. At step 718, the service provider server 240 receives data in data mapping, such as from one of the users 120A-N of the service provider team 770. At step 720, the service provider server 240 validates data with the service provider team 770. At step 721, the service provider server 240 updates the metrics in the dashboard with updated data provided by the users 120A-N. At step 722, the service provider team 770 develops a reporting framework, such as through an application provided by the service provider server 240.

At step 724, the service provider server 240 updates standard reports. At step 726, the service provider server 240 compares the data to the previous monthly data. At step 728, the service provider server 240 pulls data/metrics from a software tool, such as a dashboard tool. At step 730, the service provider server 240 analyzes data from the external software tool. At step 732, the service provider server 240 identifies trends based on previous data. At step 736, the service provider server 240 generates a summary report on the findings. At step 738, the service provider server 240 compiles the findings. At step 740, the service provider server 240 provides the report on the trends, patterns and findings to one or both of the teams 760, 770. The teams 760, 770 may review the report. At step 742, the service provider team 770 may identify one or more stakeholders to review the report, such as through a graphical user interface provided by the service provider server 240. The stakeholders may be decision makers within the organization. At step 744, the service provider server 240 may receive an input of the review of the findings by one of the stakeholders, such as through a graphical user interface.

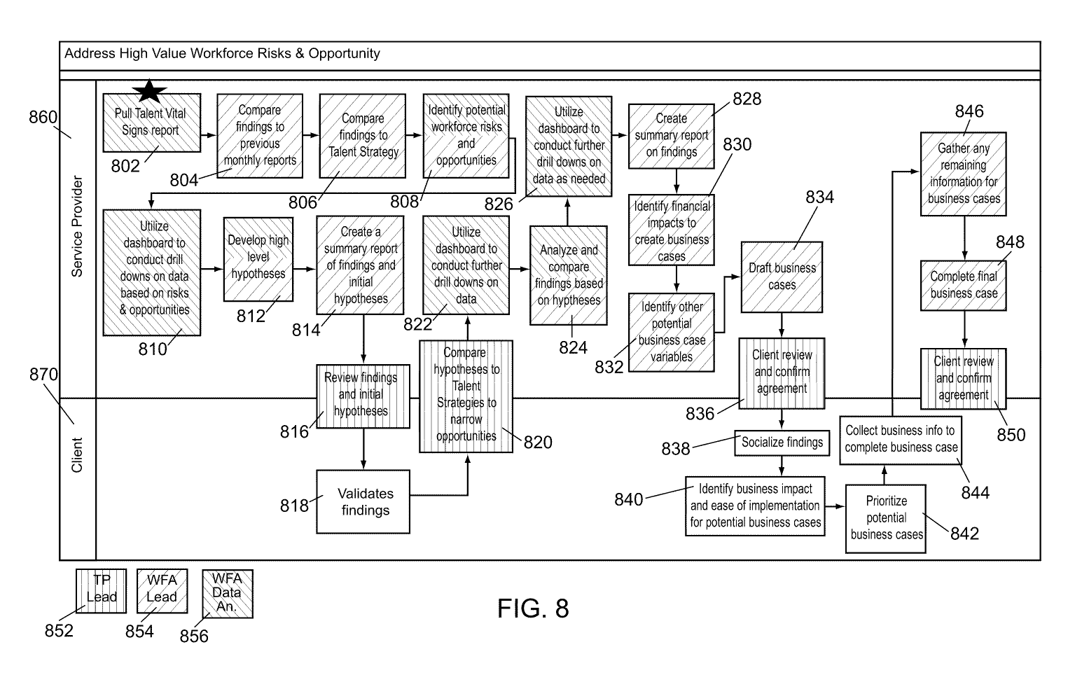

FIG. 8 is a flowchart illustrating the use of workforce analytics services to enable clients to attain corporate objectives in the system of FIG. 1, or other systems for providing workforce analytics services. The steps of the flowchart in FIG. 8 may be associated with users 120A-N on a client team 850, such as users 120A-N employed by the organization, and/or users on a service provider team 840, such as a Talent Planning lead 832, a Workforce Analytics lead 834, or a Workforce Analytics Data Analyst 836. The steps of FIG. 8 are described as being performed by, or accessed through, the service provider server 240 and/or the client devices 220A-N. For example, the service provider team 840 and/or the client team 850 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 802, the service provider team 840 reviews metrics associated with attainment of corporate objectives, or business objectives, such as through a graphical user interface provided by the service provider server 240. At step 804, the service provider team 840 performs a preliminary assessment based on the objectives. At step 806, the service provider server team 840 analyzes the results and trends related to the objectives, such as through an application running on the service provider server 240. At step 808, the service provider team 840 may identify baselines values for each metric based on the trends, such as through a graphical user interface provided by the service provider server 240. At step 810, the service provider team 840 may identify benchmarks for each metric, such as through a graphical user interface provided by the service provider server 240. At step 812, the client team 850 identifies targets for each goal, such as through a graphical user interface provided by the service provider server 240. For example, the targets may be provided by one of the users 120A-N through the graphical user interface. At step 814, the client team 850 may identify a communication plan for the goals and expectations. For example, one of the users 120A-N may provide the communication plan to the service provider, such as through a graphical user interface provided by the service provider server 240.

At step 816, the service provider team 840 compares the findings to the targets, such as through a graphical user interface provided by the service provider server 240. At step 818, the service provider server 240 performs an analysis based on high level options to address targets for goals. At step 820, the service provider server 240 may generate a summary of the findings. At step 822, the service provider server 240 may generate a report of the findings for review by one of the users 120A-N, such as through a graphical user interface provided by the service provider server 240. At step 824, the service provider server 240 may provide the report to the client team 850 and the service provider team 840, such as through a graphical user interface provided by the service provider server 240. At step 826, the service provider server 240 may communicate findings and progress to the client team 850, such as through a graphical user interface provided by the service provider server 240-N. At step 828, the service provider may receive additional business information which relate to corporate objectives from the client team 850, such as through a graphical user interface provided by the service provider server 240. At step 830, the service provider server 240 may provide the findings to the service provider team 840 and/or the client team 850, such as through a graphical user interface provided by the service provider server 240.

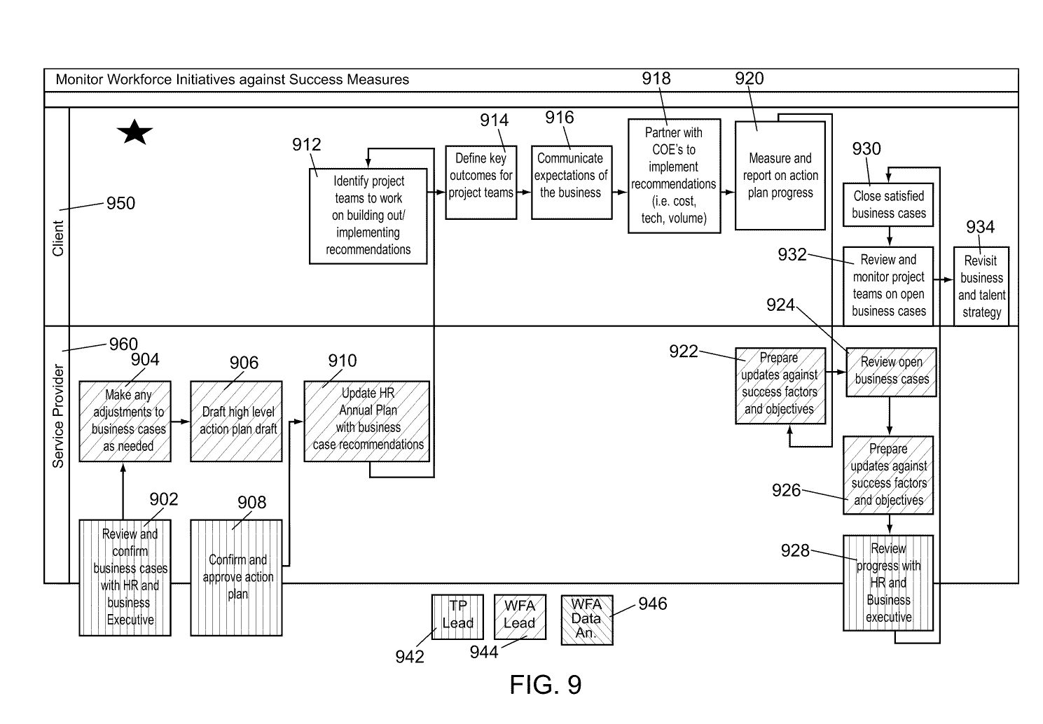

FIG. 9 is a flowchart illustrating the process for addressing workforce risks and opportunities in the system of FIG. 1, or other systems for providing workforce analytics services. The steps of the flowchart in FIG. 9 may be associated with users 120A-N on a client team 970, such as users 120A-N employed by the organization, and/or users 120A-N on a service provider team 960, such as a Talent Planning lead 952, a Workforce Analytics lead 954, or a Workforce Analytics data analyst 956. The steps of FIG. 9 are described as being performed by, or accessed through, the service provider server 240 and/or the client devices 220A-N. For example, the service provider team 960 and/or the client team 970 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 902, the service provider team 960 reviews a talent vital signs dashboard, such as sourced from the data store 245 and viewed through a graphical user interface provided by the service provider server 240. At step 904, the service provider team 960 compares findings to previous monthly reports, such as through a graphical user interface provided by the service provider server 240. At step 906, the service provider team 960 compares findings to talent strategy, such as through a graphical user interface provided by the service provider server 240. At step 908, the service provider team 960 identifies potential workforce risks and opportunities, such as through a graphical user interface provided by the service provider server 240. At step 910, the service provider team 960 utilizes a software application, such as a dashboard tool provided by the service provider server 240, to conduct drilldowns on data based on risks and opportunities. At step 912, the service provider team 960 determines high level hypotheses, such as through the dashboard tool provided by the service provider server 240. At step 914, the service provider server 240 generates a summary report of findings and initial hypotheses. At step 916, the service provider server 240 provides the findings and initial hypotheses to the service provider team 960 and/or the client team 970. At step 918, the service provider server 240 receives a confirmation from the service provider team 960 and/or the client team 970 that the findings are valid according to the business context. At step 920, the service provider team 960 compares the hypothesis to talent strategies with the client team 970, such as through a graphical user interface provided by the service provider server 240. At step 922, the service provider team 960 utilizes a dashboard tool, such as a dashboard tool provided by the service provider server 240, to perform further drill downs on data. At step 924, the service provider team 960 analyzes and compares findings based on the hypotheses, such as through a graphical user interface provided by the service provider server 240. At step 926, the service provider team 960 utilizes tools, such as the dashboard tool provided by the service provider server 240, to perform further drill downs of data as necessary.

At step 928, the service provider server 240 generates a summary report on the findings. At step 930, the service provider team 960 identifies the financial impacts in order to create business cases, such as through a graphical user interface provided by the service provider server 240. At step 932, the service provider team 960 identifies other potential business case variables, such as through a graphical user interface provided by the service provider server 240. At step 934, the service provider server 240 generates business cases based on the provided information. At step 936, the service provider server 240 provides the business cases to the service provider team 960 and/or the client team 970. At step 938, the client team 970 electronically socializes the findings, such as by posting the findings on an intranet, emailing the findings to the users 120A-N, or generally any mechanism of electronically socializing the findings. At step 940, the client team 970 identifies the business impact and ease of implementation for potential business cases, such as through a graphical user interface provided by the service provider server 240. At step 942, the client team 970 prioritizes the potential business cases, such as through a graphical user interface provided by the service provider server 240. At steps 944-946, the client team 970 retrieves business information and provides the information to the service provider team 960, such as through a graphical user interface provided by the service provider server 240, to generate the business case, such as external enterprise systems. At step 948, the service provider server 240 finalizes the business case. At step 950, the service provider server 240 provides the business case to the service provider team 960 and/or the client team 970. The service provider team 960 and/or the client team 970 may review and/or edit the business case, such as through a graphical user interface provided by the service provider server 240.

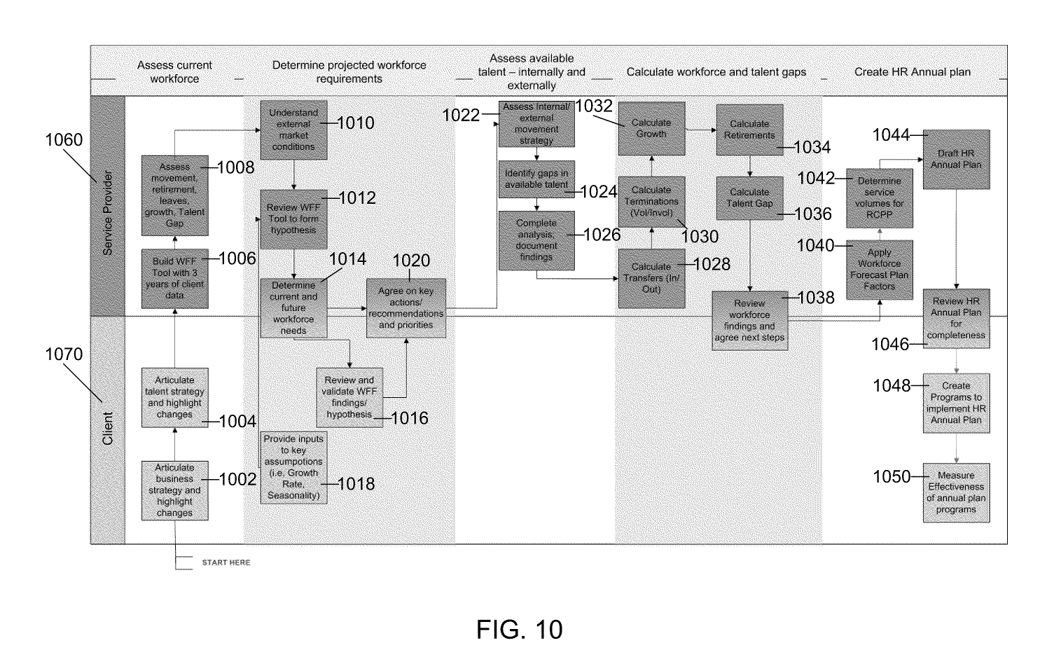

FIG. 10 is a flowchart illustrating the monitoring of workforce initiatives against success measures in the system of FIG. 1, or other systems for providing workforce analytics services. The steps of FIG. 10 may be associated with users 120A-N on a client team 1050, such as users 120A-N employed by the organization, and/or users 120A-N on a service provider team 1060, such as a Talent Planning lead 1042, a Workforce Analytics lead 1044, or a Workforce Analytics data analyst 1046. The steps of FIG. 10 are described as being performed by, or accessed through, the service provider server 240 and/or the client devices 220A-N. For example, the service provider team 1060 and/or the client team 1050 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 1002, the service provider server 240 provides the business cases to the service provider team 1060. The service provider team 1060 may review and/or confirm the business cases, such as through a graphical user interface provided by the service provider server 240. At step 1004, the service provider team 1060 makes any necessary adjustments and updates, such as through a graphical user interface provided by the service provider server 240. At step 1006, the service provider server 240 may generate a high level action plan, such as an action plan capable of accomplishing business objectives of the business cases. At step 1008, the service provider server 240 may provide the high level action plan to the service provider team 1060 and/or the client team 1050. The team 1050, 1060 may review, edit and/or approve of the high level action plan, such as through a graphical user interface provided by the service provider server 240. At step 1010, the service provider server 240 may update the annual plan with the business case recommendations to the service provider team 1060 and/or the client team 1050.

At step 1012, the client team 1050 may identify project teams to work on implementing recommendations, such as through a graphical user interface provided by the service provider server 240. For example, the client team 1050 may provide available project teams to support the action plan activities. At step 1014, the client team 1050 determines the key outcomes for each project team, such as through an application provided by the service provider server 240. At step 1016, the client team 1050 provides the expectations of the business to include in the action plan to the service provider server 240. At step 1018, the client team 1050 implements recommendations, such as through a partnership with a third party. At step 1020, the client team 1050 measures the progress of the action plan and provides a report on the action plan progress in collaboration with service provider server 240 or third party, such as through an application provided by the service provider server 240. At step 1022, the service provider team 1060 prepares updates against success factors and objectives, such as through a graphical user interface provided by the service provider server 240. At step 1024, the service provider team 1060 reviews the open business cases, such as through a graphical user interface provided by the service provider server 240. At step 1026, the service provider team 1060 prepares updates against success factors and objectives, such as through an application provided by the service provider server 240. At step 1028, the service provider team 1060 reviews the progress of the plan, such as through a graphical user interface provided by the service provider server 240. At step 1030, the service provider team 1060 closes any completed business cases, such as through a graphical user interface provided by the service provider server 240. At step 1032, the service provider team 1060 and/or the client team 1050 may monitor the progress of project teams on open business cases, such as through a graphical user interface provided by the service provider server 240. At step 1034, the client team 1050 reviews any potential impacts from the business and talent strategy, such as through a graphical user interface provided by the service provider server 240.

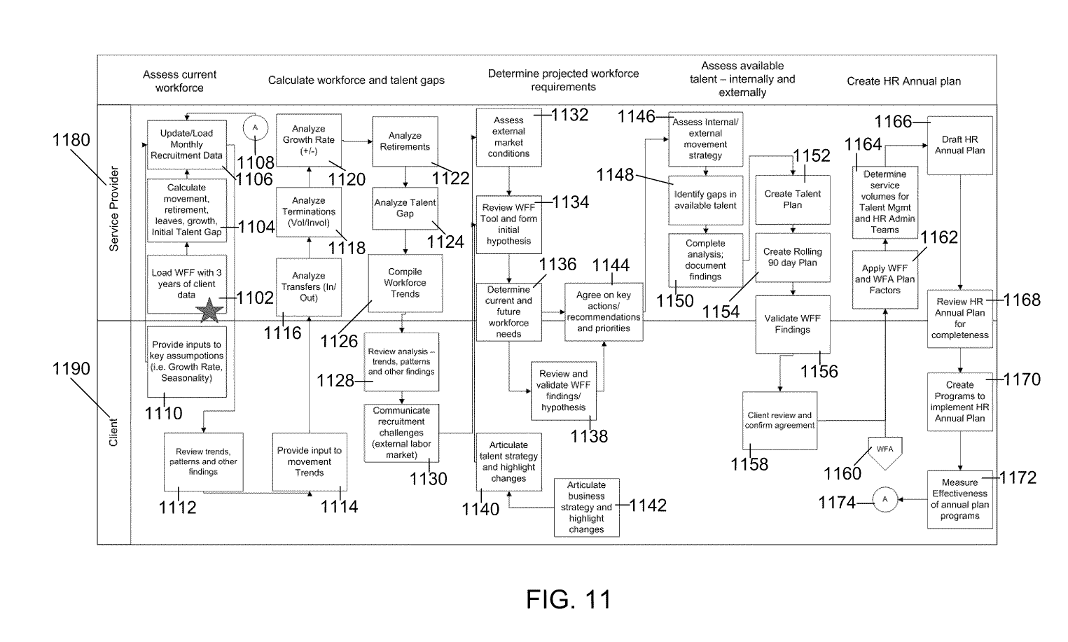

FIG. 11 is a flowchart illustrating the creation of an annual plan in the system of FIG. 1, or other systems for providing workforce planning services. The steps of FIG. 11 are described as being performed by the service provider. The steps of the flowchart in FIG. 11 may be associated with users 120A-N on a client team 1170, such as users 120A-N employed by the organization, and/or users 120A-N on a service provider team 1160, such as users 120A-N associated with the services provided by the service provider server 240. The steps of FIG. 11 are described as being performed by, or accessed through, the service provider server 240 and/or the client devices 220A-N. For example, the service provider team 1160 and/or the client team 1170 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 1102, the client team 1170 identifies business strategies and objectives for each business strategy, such as through a graphical user interface provided by the service provider server 240. At step 1104, the client team 1170 identifies the talent strategies and highlights any changes in the talent strategies, such as through a graphical user interface provided by the service provider server 240. At step 1106, the service provider team 1160 populates an external software application, such as a workforce planning tool provided by the service provider server 240, with three years of historical data of the organization. At step 1108, the service provider server 240 analyzes potential sources of change in employee data which may create a talent gap. At step 1110, the service provider team 1160 may identify external market conditions, such as through a graphical user interface provided by the service provider server 240. At step 1112, the service provider team 1160 may review the workforce planning tool provided by the service provider server 240 to generate a hypothesis on the workforce data. At step 1114, the service provider team 1160 collaborates with the client team 1170 to determine the current and future workforce needs, such as through a collaboration tool provided by the service provider server 240. At step 1116, the service provider server 240 provides the workforce tool findings and hypotheses to the teams 1160, 1170. The teams 1160, 1170 may review and/or validate the findings, such as through a graphical user interface provided by the service provider server 240. At step 1118, the service provider server 240 may receive inputs to key assumptions, such as growth rate, and seasonality. At step 1120, the service provider team 1160 may identify key actions and recommendations and priorities thereof, such as through a graphical user interface provided by the service provider server 240.

At step 1122, the service provider server 240 analyzes strategies related to the internal and external movement of employees of the organization. At step 1124, the service provider server 240 identifies gaps in available talent, such as shortage or surplus of talent. At step 1126, the service provider server 240 performs the analysis and stores the results. At step 1128, the service provider server 240 calculates the transfer of employees in/out of the organization. At step 1130, the service provider server 240 calculates the terminations of the organization. At step 1132, the service provider server 240 calculates the expected growth of the organization. At step 1134, the service provider server 240 may calculate expected retirements of the organization. At step 1136, the service provider server 240 may calculate the expected talent gap of the organization. At step 1138, the service provider server 240 may provide the workforce data to the service provider team 1160 and/or the client team 1170. The teams 1160, 1170 may review the findings. At step 1140, the service provider team 1160 may apply workforce plan factors to the data, such as through a graphical user interface provided by the service provider server 240. At step 1142, the service provider server 240 may determine service volumes, such as by processing information provided by the teams 1160, 1170. At step 1144, the service provider server 240 may generate an annual plan. At step 1146, the service provider server 240 may provide the annual plan to the service provider tem 1160 and/or the client team 1170. The teams 1160, 1170 may review the annual plan for completeness. At step 1148, the client team 1170 may generate one or more programs to implement the annual plan, such as through an application provided by the service provider server 240. At step 1150, the client team 1170 may monitor the programs and may measure the effectiveness of the annual plan programs, such as through an application provided by the service provider server 240.

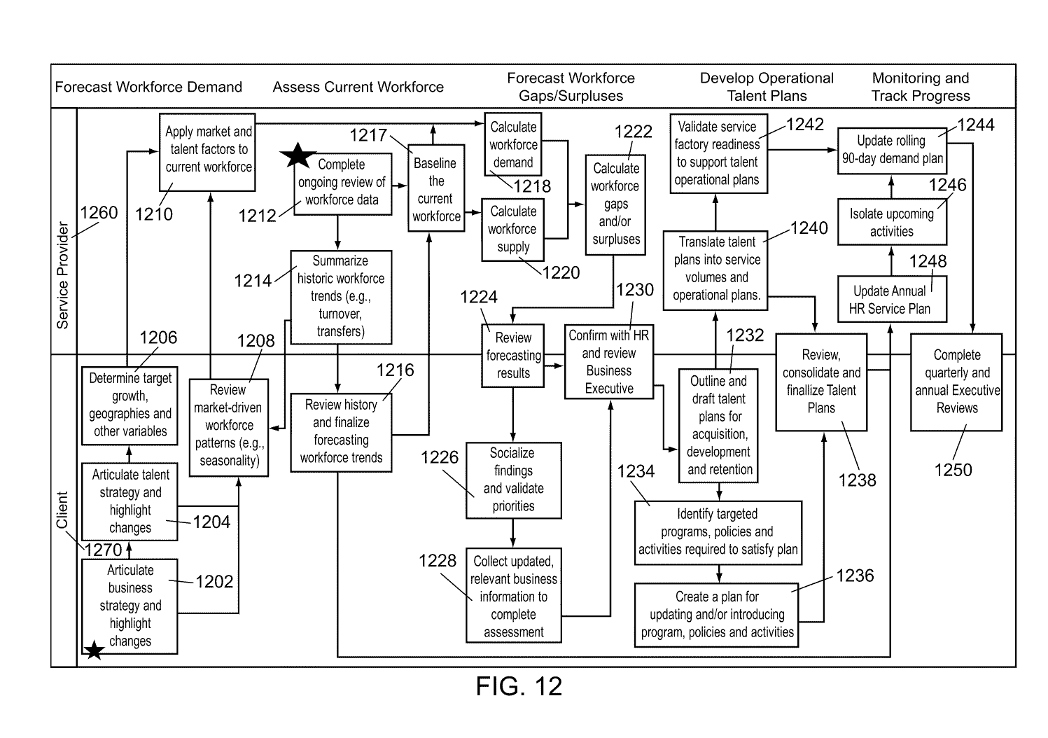

FIG. 12 is a flowchart illustrating an alternative creation of an annual plan in the system of FIG. 1, or other systems for providing workforce planning services. The steps of the flowchart in FIG. 12 may be associated with users 120A-N on a client team 1290, such as users 120A-N employed by the organization, and/or users 120A-N on a service provider team 1280, such as users 120A-N associated with the services provided by the service provider server 240. The steps of FIG. 12 are described as being performed by, or accessed through, the service provider server 240 and/or the client devices 220A-N. For example, the service provider team 1280 and/or the client team 1290 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 1202, the service provider server 240 retrieves historical workforce data of an organization for the last three years, such as through the data store 245. At step 1204, the service provider server 240 determines the workforce movement, workforce retirements, workforce leaves, workforce growth, and any initial talent gap of the organization. At step 1206, the service provider server 240 receives and updates monthly recruitment data, such as from the service provider team 1280, and/or the client team 1290. At step 1208, the service provider team 1280 may update additional monthly data describing the workforce of the organization, such as through a graphical user interface provided by the service provider server 240. At step 1210, the service provider server 240 may determine inputs related to the monthly data, such as growth rate, seasonality, etc., such as inputs provided through a graphical user interface by the client team 1290 and/or the service provider team 1280. At step 1212, the client team 1290 may review trends, patterns and other findings based on the updated monthly recruitment data, such as through a graphical user interface provided by the service provider server 240. At step 1214, the client team 1290 may provide the input to movement trends to the service provider server 240, such as through a graphical user interface provided by the service provider server 240. At step 1216, the service provider server 240 may analyze the transfer of employees into and out of the workforce and/or into and out of individual workforce segments.

At step 1218, the service provider server 240 may analyze terminations in the workforce. At step 1220, the service provider server 240 may analyze the growth rate within the workforce. At step 1222, the service provider server 240 may analyze retirements within the workforce. At step 1224, the service provider server 240 may analyze any talent gap in the workforce. At step 1226, the service provider server 240 may compile workforce trends. At step 1228, the client team 1290 may review the analysis, the trends, the patterns and other findings, such as through a graphical user interface provided by the service provider server 240. At step 1230, the client team 1290 may receive information describing recruitment challenges, such as external labor market conditions, through a graphical user interface provided by the service provider server 240. At step 1232, the service provider team 1280 may assess the received external market conditions, such as through a graphical user interface provided by the service provider server 240. At step 1234, the service provider team 1280 may generate an initial hypothesis, such as through an application provided by the service provider server 240. At step 1236, the service provider server 240 may determine the current and future workforce needs of the organization, such as by analyzing information provided by the client team 1290, and/or the service provider team 1280. At step 1238, the service provider server 240 may provide the analyses and hypothesis for review by the client team 1290 and/or the service provider tem 1280. At step 1244, the service provider team 1280 may receive agreed upon key actions, recommendations and priorities from the client team 1290, such as through a graphical user interface provided by the service provider server 240.

At step 1246, the service provider team 1080 may assess an internal and external workforce movement strategy, such as through a graphical user interface provided by the service provider server 240. At step 1248, the service provider server 240 may identify gaps in the available workforce. At step 1250, the service provider server 240 may complete the analysis and store, print the findings, or provide the findings to the teams 1280, 1290. At step 1252, the service provider server 240 may generate a talent action plan. At step 1254, the service provider server 240 may create a rolling 90-day plan. At step 1256, the service provider server 240 may validate the findings with the client, such as through a graphical user interface provided by the service provider server 240. At step 1258, the service provider server 240 may provide the findings and the plans, such as to the teams 1280, 1290, and may receive a confirmation of the findings and the plans, such as from the teams 1280, 1290. At step 1260, the service provider server 240 may perform an analysis of the workforce. At step 1262, the service provider server 240 may apply plan factors determined by the analysis to the action plan. At step 1264, the service provider server 240 may determine the service volumes. At step 1266, the service provider server 240 may generate an annual plan. At step 1268, the service provider server 240 may provide the annual plan for review by the teams 1280, 1290, such as through a graphical user interface provided by the service provider server 240. At step 1270, the client team 1290 may generate one or more programs for implementing the annual plan, such as through an application provided by the service provider server 240. At step 1272, the client team 1290 may measure the effectiveness of the programs for implementing the annual plan, such as through a monitoring application provided by the service provider server 240. At step 1274, the service provider server 240 may output the measured effectiveness of the programs for implementing the annual plan, such as to the teams 1280, 1290.

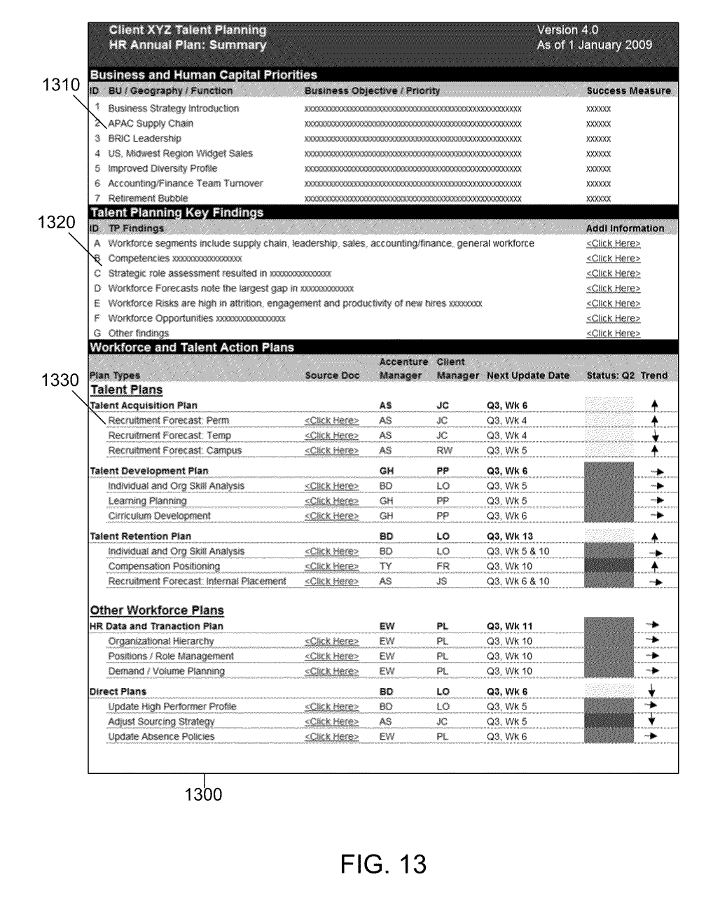

FIG. 13 is a flowchart illustrating progress monitoring in the system of FIG. 1, or other systems for providing workforce planning services. The steps of the flowchart in FIG. 13 may be associated with users 120A-N on a client team 1370, such as users 120A-N employed by the organization, and/or users 120A-N on a service provider team 1360, such as users 120A-N associated with the services provided by the service provider server 240. The steps of FIG. 13 are described as being performed by, or accessed through, the service provider server 240 and/or the client devices 220A-N. For example, the service provider team 1360 and/or the client team 1370 may provide data to the service provider server 240 though the client devices 220A-N, receive data from the service provider server 240 through the client devices 220A-N, or interact with a graphical user interface provided by the service provider server 240 through the client devices 220A-N to access one or more applications running on the service provider server 240. However, the steps may also be performed by the processor of the service provider server 240, or by any other hardware component of the service provider server 240.

At step 1302, the client team 1370 identifies the business strategy and determines the changes in the strategy, such as through a graphical user interface provided by the service provider server 240. At step 1304, the client team 1370 identifies a talent strategy and changes in the strategy, such as through a graphical user interface provided by the service provider server 240. At step 1306, the client team 1370 may determine the target growth, geographies and other variables, such as through a graphical user interface provided by the service provider server 240. At step 1308, the client team 1370 may analyze market-driven workforce patterns, such as seasonality, such as through an application provided by the service provider server 240. At step 1310, the service provider server 240 applies market and talent factors to the current workforce. At step 1312, the service provider team 1360 begins on ongoing review of workforce data, such as through a graphical user interface provided by the service provider server 240. At step 1314, the service provider server 240 generates a summary of historic workforce trends, such as turnovers and/or transfers.

At step 1316, the client team 1370 may review workforce historical data and may forecast workforce trends, such as through a graphical user interface provided by the service provider server 240. At step 1317, the service provider server 240 may identify the baseline of the current workforce data, such as through a graphical user interface provided by the service provider server 240. At step 1318, the service provider server 240 may calculate workforce demand. At step 1320, the service provider server 240 may calculate workforce supply. At step 1322, the service provider server 240 may calculate workforce gaps and/or surpluses. At step 1324, the service provider server 240 may analyze forecasting results with the client. At step 1326, the client team 1370 may electronically socialize findings, such as by posting on an intranet site, and validating priorities. At step 1328, the service provider server 240 may receive updated, relevant business information in order to complete an assessment, such as from the client team 1370 and/or the service provider team 1360. At step 1330, the service provider team 1360 may review the assignment of a business executive, such as through a graphical user interface provided by the service provider server 240. At step 1332, the service provider team 1360 may assist the client team 1370 with the generation of talent plans for acquisition of talent, development of talent, and retention of talent, such as through a collaboration application provided by the service provider server 240.

At step 1334, the service provider team 1360 may assist the client team 1370 with the identification of targeted programs, policies and activities required to complete the talent plans, such as through a collaboration application provided by the service provider server 240. At step 1336, the service provider team 1360 may assist the client team 1370 in the generation of a plan for updating and/or introducing programs, policies and activities, such as through a collaboration interface provided by the service provider server 240. At step 1340, the service provider server 240 may translate the talent plans into service volumes and operational plans. At step 1342, the service provider server 240 may validate service factory readiness to support talent operational plans. At step 1344, the service provider team 1360 may update the rolling 90-day demand plan, such as through a graphical user interface provided by the service provider server 240. At step 1346, the service provider team 1360 may isolate upcoming activities, such as through a graphical user interface provided by the service provider server 240. At step 1348, the service provider server 240 may update the annual service plan. At step 1350, the service provider team 1360 may assist the client team 1370 with the generation of the quarterly and annual executive reviews, such as through a collaboration application provided by the service provider server 240.

FIG. 14 is a screenshot of a user interface 1400 displaying an annual plan in the system of FIG. 1, or other systems for providing workforce planning services. The user interface 1400 includes a business section 1410, a talent planning section 1420, and a talent action plan section 1430. The business section 1410 displays one or more critical business units, one or more business objective identified for each business unit, and a metric, or success measure, for measuring whether the business objective is being accomplished. The talent planning section 1420 displays summary talent planning findings relevant to the organization, such as talent planning risks. The talent action plan section 1430 displays a summary of the talent action plans in progress for the organization. The talent action plan section 1430 may also display the status of the talent action plans and the trend of the talent action plans. The trend may indicate whether the talent action plan is accomplishing the related business objective.

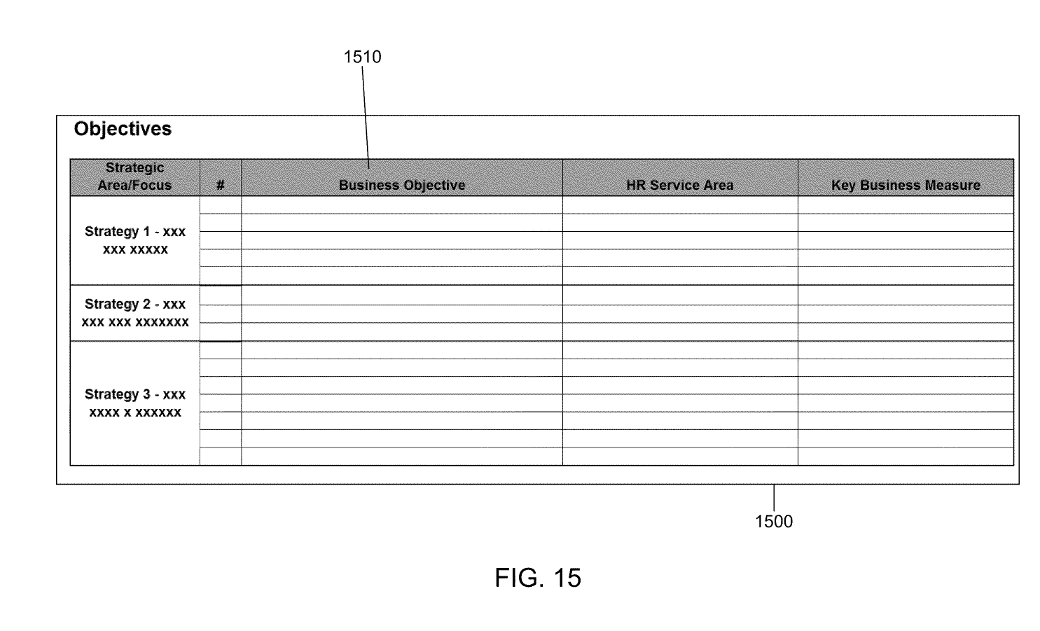

FIG. 15 is a screenshot of a user interface 1500 displaying a strategic plan workbook in the system of FIG. 1, or other systems for providing workforce planning services. The user interface 1500 may include a navigation section 1510, and a strategic plan table 1520. The strategic plan table 1520 may display one or more strategic plans being monitored by the service provider server 240. For example, in the user interface 1500, the strategic plans are understanding the client, creating the strategic plan and living the plan.

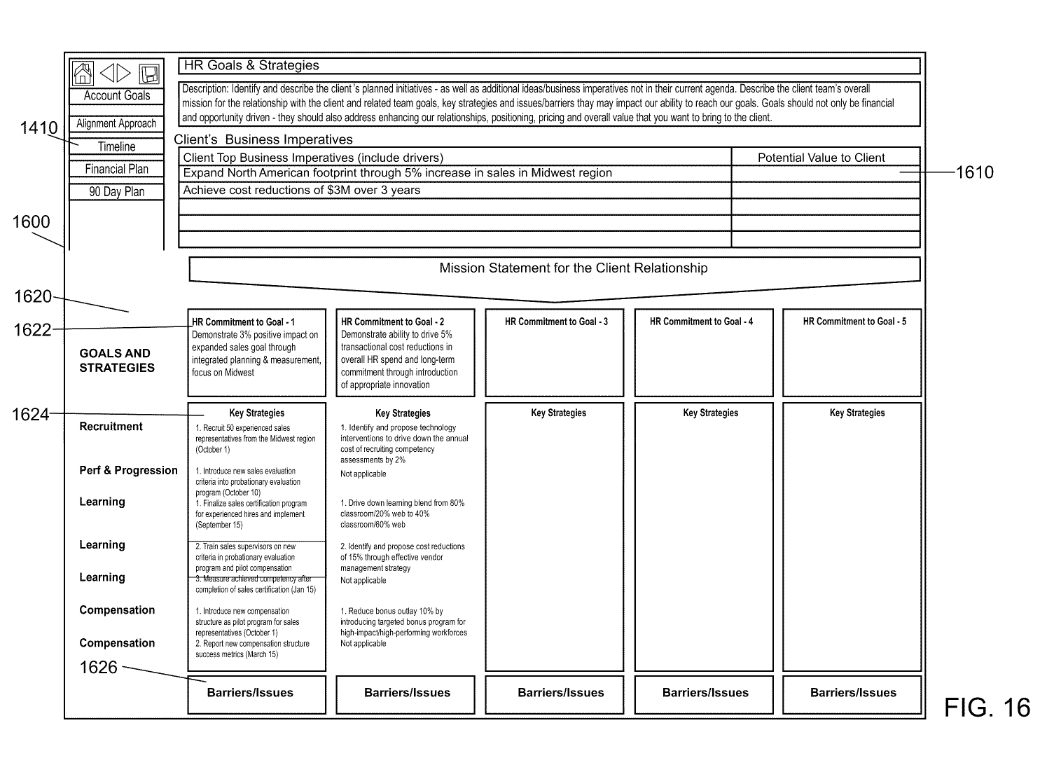

FIG. 16 is a screenshot of a user interface 1600 displaying a business objectives table in the system of FIG. 1, or other systems for providing workforce planning services. The user interface 1600 may display a business objectives table 1610. The business objectives table 1610 displays one or more strategies being implemented by the organization, the related business objective, the service area and the key business measure, or metric.

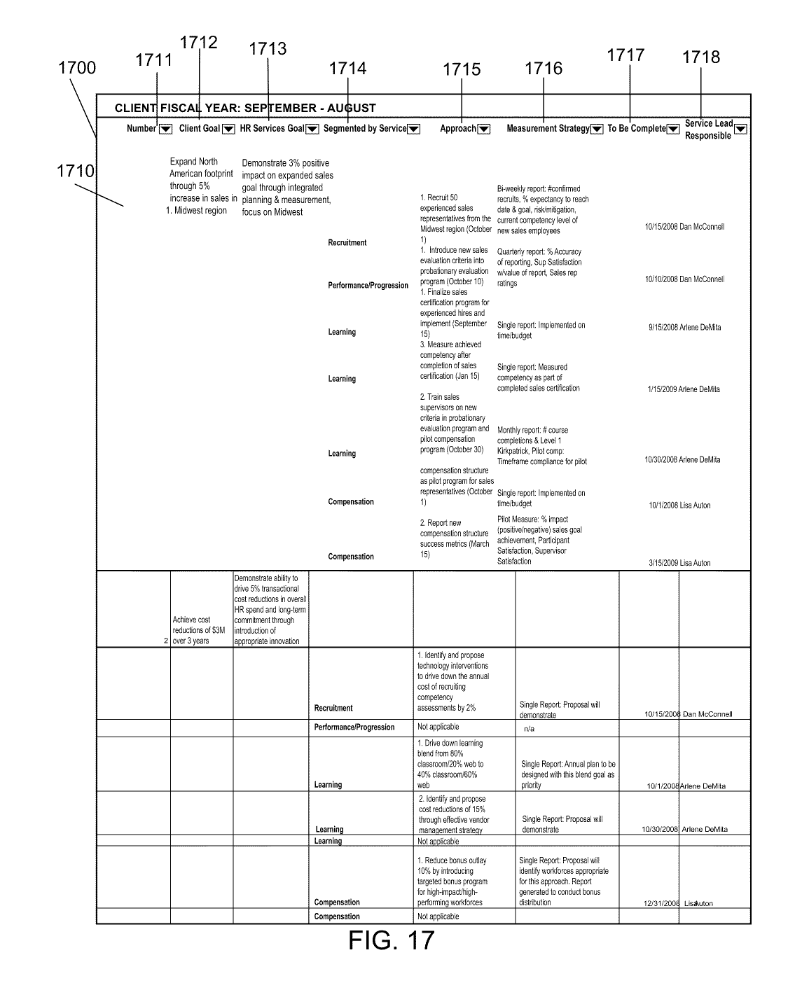

FIG. 17 is a screenshot of a user interface 1700 displaying goals and strategies in the system of FIG. 1, or other systems for providing workforce planning services. The user interface 1700 includes a navigation section 1510, a business imperatives table 1710, and a goals and strategies section 1720. The goals and strategies section 1720 includes goals 1722, strategies 1724 and issues 1726.

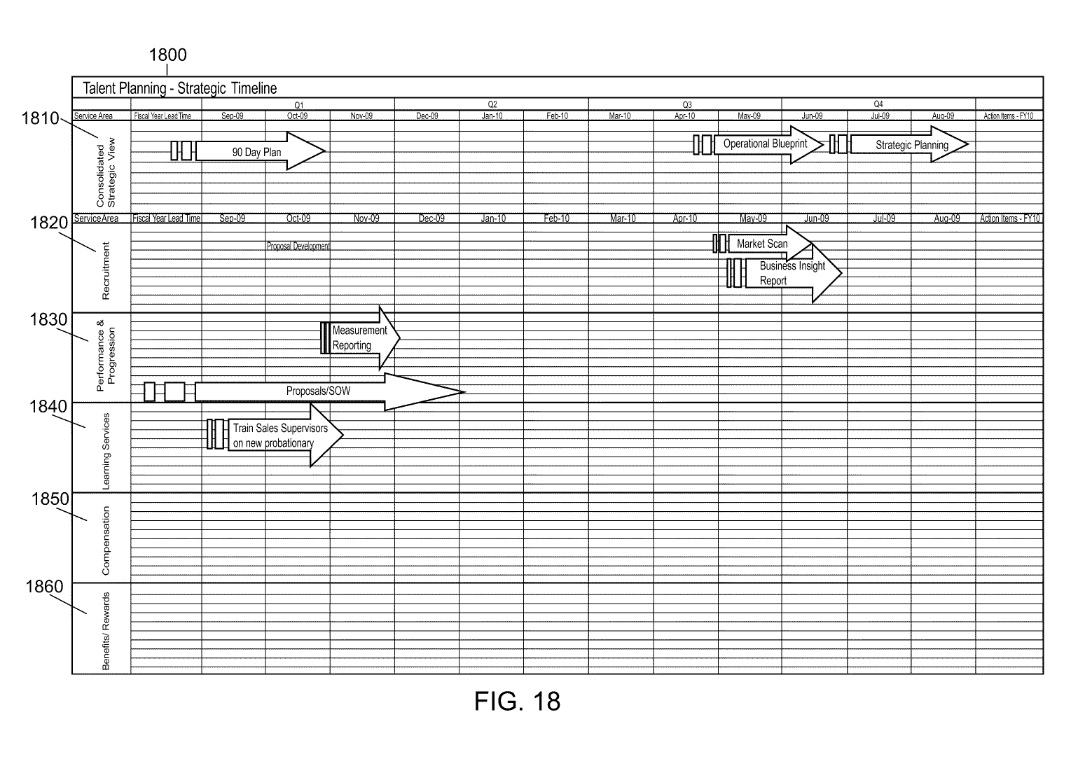

FIG. 18 is a screenshot of user interface 1800 displaying annual goals in the system of FIG. 1, or other systems for providing workforce planning services. The user interface 1800 includes a client table 1810. The client table 1810 includes a number column 1811, a client goal column 1812, a services goal column 1813, a service segment column 1814, an approach column 1815, a measurement strategy column 1816, a complete date column 1817, and a service lead responsible column 1818.

In operation, the client goal column 1812 displays current client goals and the services goal column 1813 displays current services goals. The service segment column 1814 allows a user A 120A to segment the client table 1810 based on service areas. The approach column 1815 displays approaches to achieving the associated goals. The measurement strategy column 1816 displays the strategy for measuring whether the associated goals are being achieved. The complete date column 1817 displays a complete date for the associated goal and the service lead responsible column 1818 displays the person responsible for achieving the associated goal.

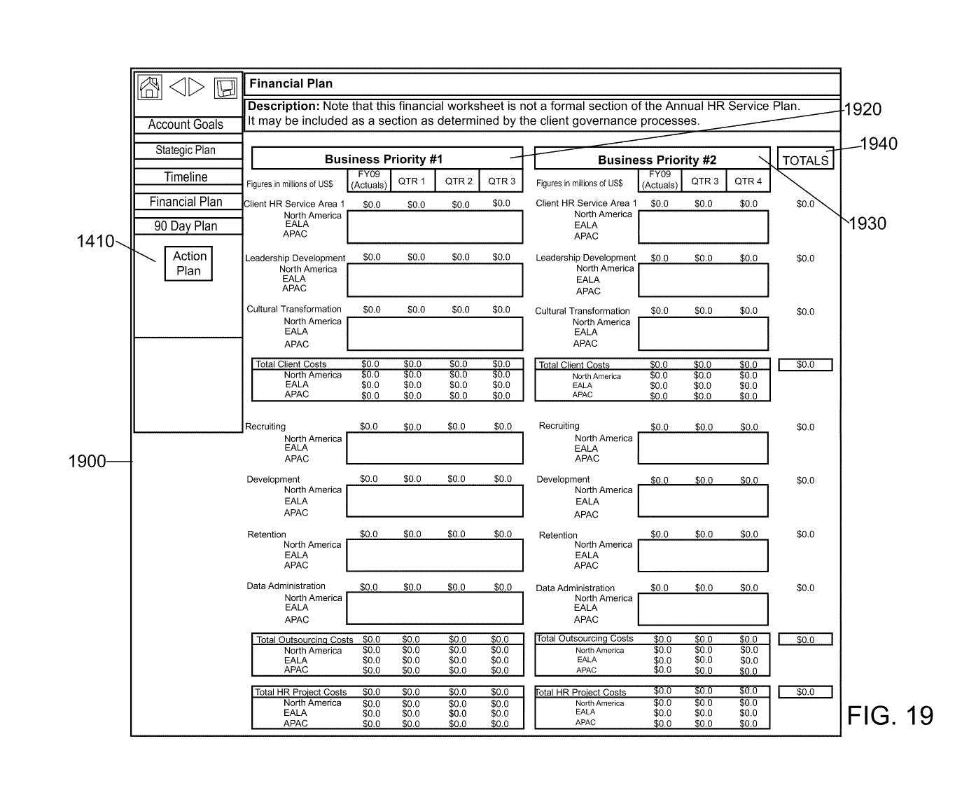

FIG. 19 is a user interface 1900 displaying a strategic timeline in the system of FIG. 1, or other systems for providing workforce planning services. The user interface 1900 includes a consolidated strategic view timeline 1910, a recruitment timeline 1920, a performance timeline 1930, a learning services timeline 1940, a compensation timeline 1950 and a benefits timeline 1960. The timelines 1910, 1920, 1930, 1940, 1950, 1960 display graphical indicators which indicate the expected timeframe for accomplishing one or more goals during the timeframe.

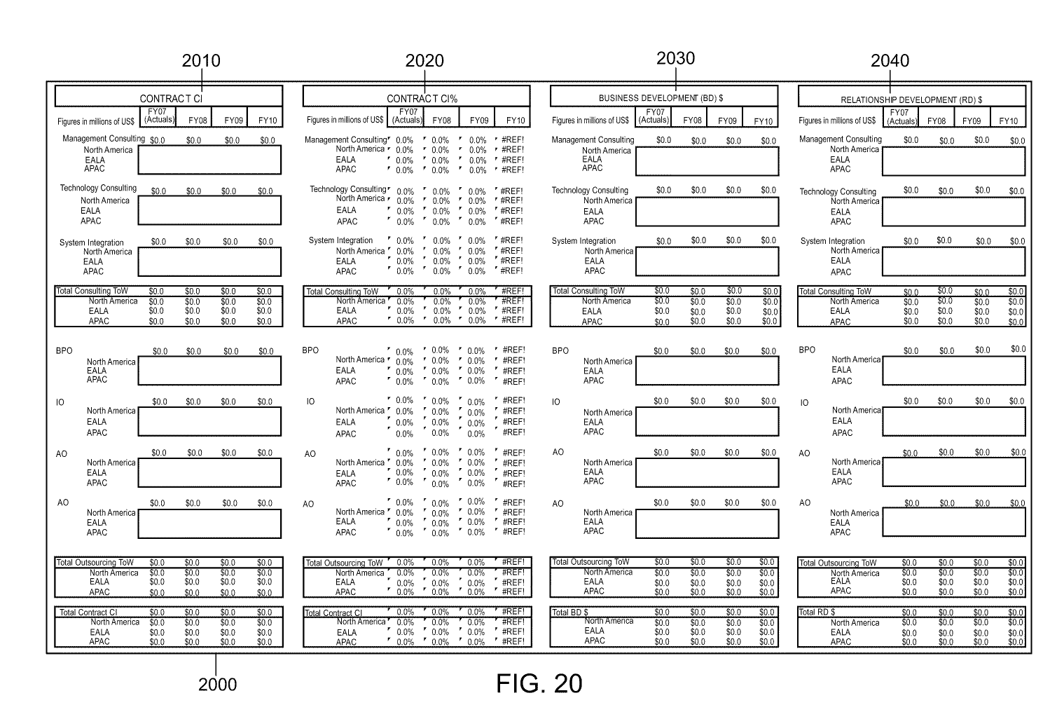

FIG. 20 is a user interface 2000 displaying financial plan information in the system of FIG. 1, or other systems for providing workforce planning services. The user interface 2000 includes a navigation section 1510, a business priority #1 financial plan 2020, a business priority #2 financial plan 2030, and a totals 2040. The financial plans 2020, 2030 display the financial results segmented based on geographic areas.

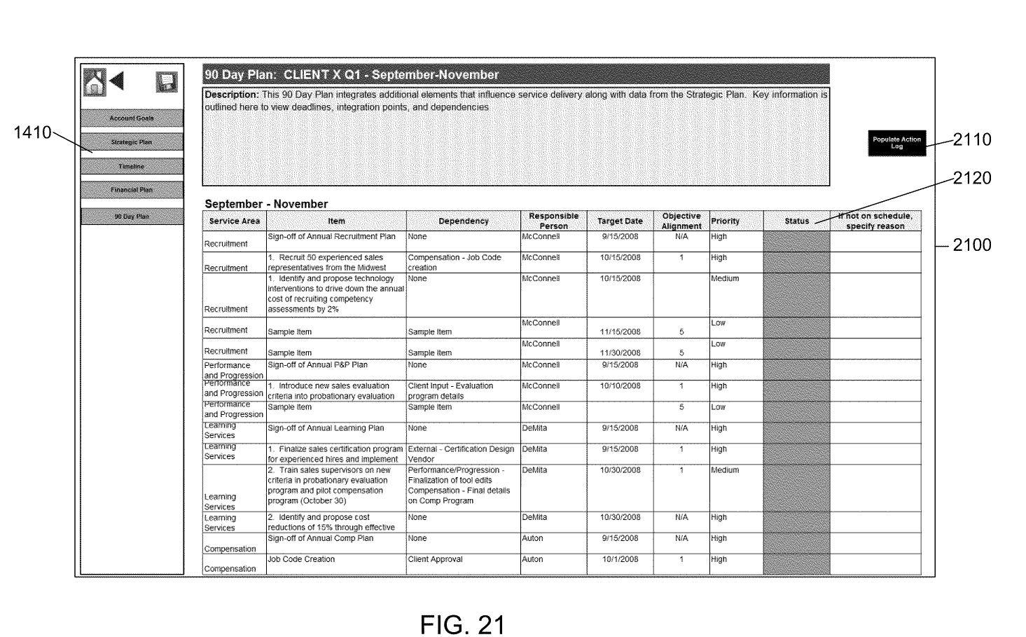

FIG. 21 is a user interface 2100 displaying additional financial plan information in the system of FIG. 1, or other systems for providing workforce planning services. The user interface 2100 includes a contract financial plan 2110, a contract % financial plan 2120, a business development financial plan 2130, and a relationship development financial plan 2140. The financial plans 2110, 2120, 2130, 2140 display the financial results segmented based on geographic areas.

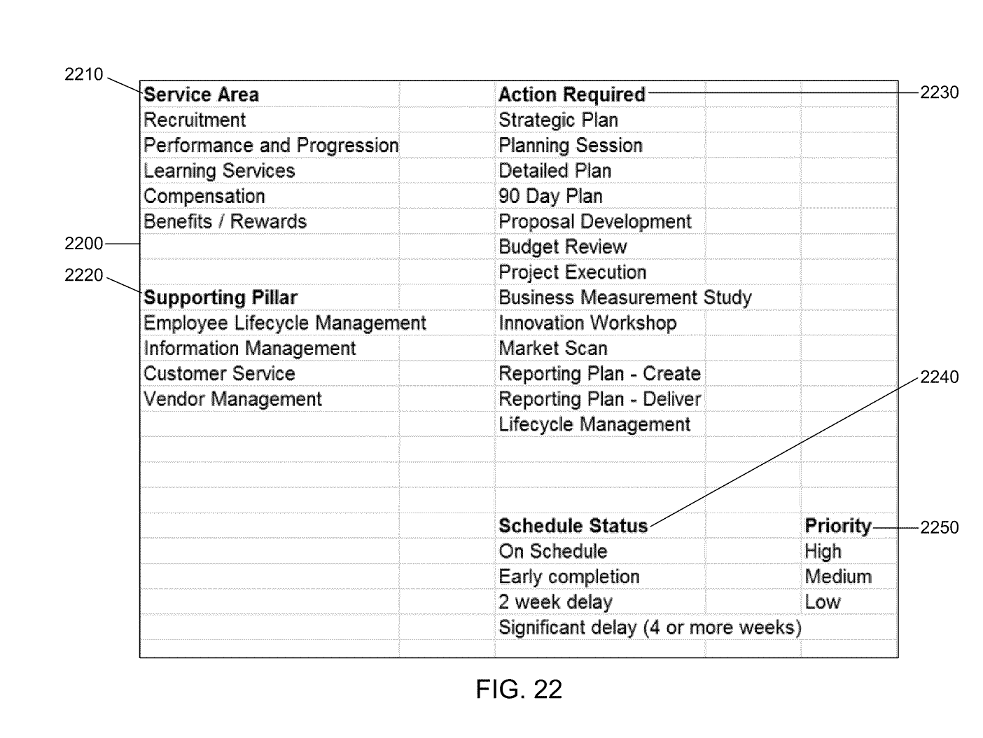

FIG. 22 is a user interface 2200 displaying a 90-day plan in the system of FIG. 1, or other systems for providing workforce planning services. The user interface 2200 includes a navigation section 1510, a populate action log button 2210, and a 90-day plan table 2220. The 90-day plan table 2220 displays the service area, dependency, responsible person, target date, objective alignment, priority, status, and reason for each 90-day plan item.

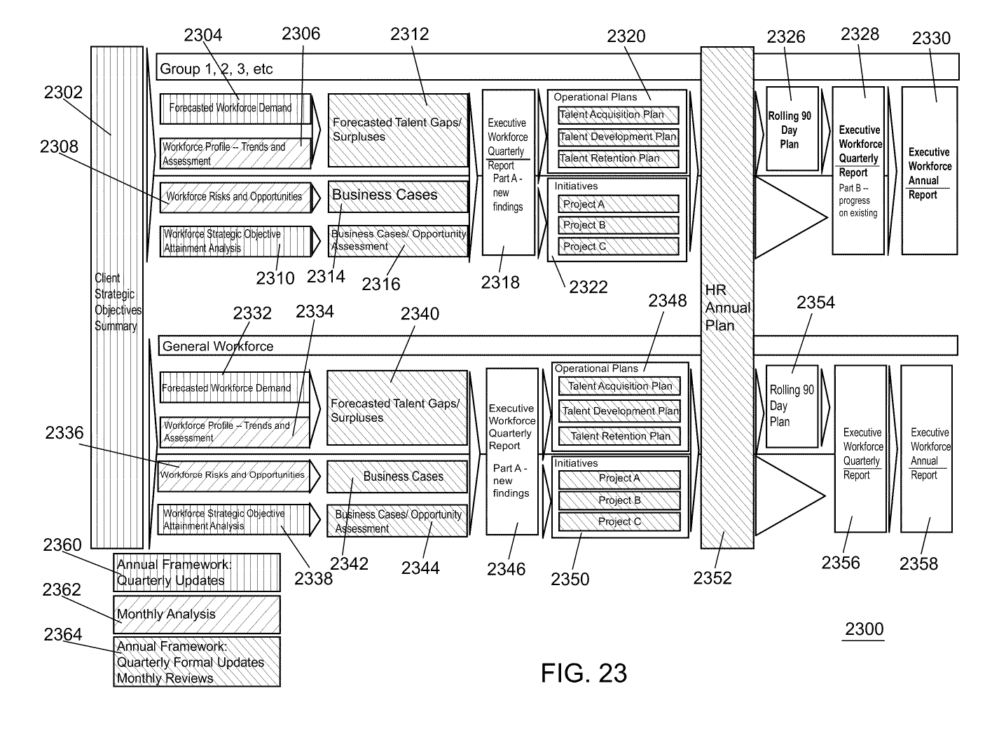

FIG. 23 is a screenshot of a user interface 2300 displaying text options in the system of FIG. 1, or other systems for providing workforce planning services. The user interface 2300 includes a service area section 2310, a supporting pillar 2320, an action required section 2330, a schedule status section 2340, and a priority section 2350. The service area section 2310 displays the service values used in the system 100. The supporting pillar section 2320 displays the supporting pillars used in the system 100. The action required section 2330 displays the actions used in the system 100. The schedule status section 2240 displays the schedule statuses used in the system 100, and the priority section 2350 displays the priorities used in the system 100.

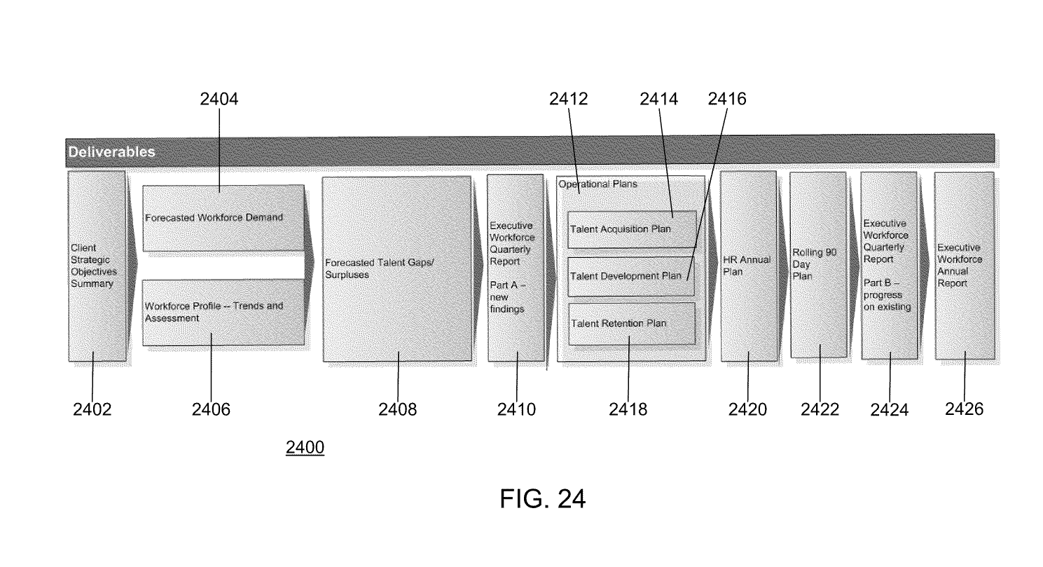

FIG. 24 is a screenshot of a talent planning service workflow 2400 in the system of FIG. 1, or other systems for providing workforce planning services. The workflow 2400 may include a workflow for individual groups and a workflow for the general workforce. The workflow for individual groups begins with a client strategic objectives summary 2402. The workflow may then progress to forecasted workforce demand 2404, workforce profile trends and assessments, workforce risks and opportunities, and workforce strategic objective attainment analysis. The workflow then progresses to forecasted talent gaps/surpluses 2412, business cases 2414, and business cases and/or opportunity assessments 2416. The workflow may then progress to the executive workforce quarterly report 2418 for each talent plan, followed by the operational plans 2420 and the initiatives 2422 for each project. The workflow then progresses to the annual plan 2452, followed by the rolling 90-day plan 2426. The workflow then progresses to part B of the executive workforce quarterly report 2428 and lastly the executive workforce annual report 2430.

The general workforce workflow also beings with the client strategic objectives summary 2402. The workflow then progresses to forecasted workforce demand 2432, workforce profile, trends and assessment 2434, workforce risks and opportunities 2436, and a workforce strategic objective attainment analysis 2438. The workflow then progresses to the forecasted talent gaps/surpluses 2440, business cases 2442, and business cases/opportunity assessment 2444. The workflow then progresses to the executive workforce quarterly report 2446. The workflow then progresses to the operational plans 2448, such as the talent acquisition plan, the talent development plan, and the talent retention plan, and the initiatives 2450. The workflow then progresses to the annual plan 2452, followed by a rolling 90-day plan 2454. The workflow then progresses to the executive workflow quarterly report 2456 followed by the executive workforce annual report 2458. One or more segments of the workflow may be associated with annual framework quarterly updates 2460, monthly analysis 2462, and an annual framework quarterly formal updates 2464.

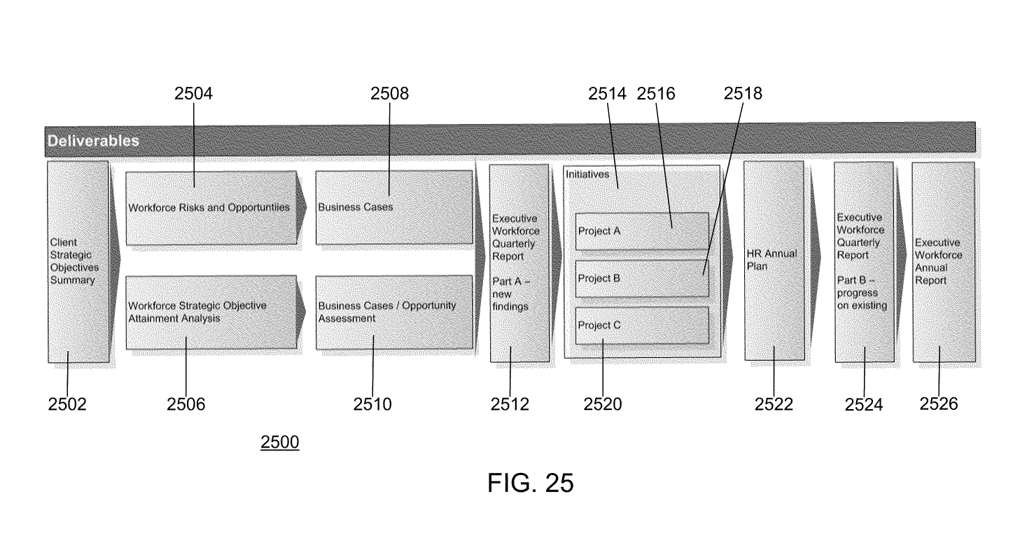

FIG. 25 is a user interface 2500 displaying talent planning deliverables workflow in the system of FIG. 1, or other systems for providing workforce planning services. The workflow beings with the client strategic objectives summary 2502 and then progresses to the forecasted workforce demand 2504, and the workforce profile, trends, and assessments 2506. The workflow then progresses to the forecasted talent gaps/surpluses 2508, followed by the executive workforce quarterly report 2510. The workflow then progresses to operational plans 2512, such as talent acquisition plans 2514, talent development plans 2514, and talent retention plans 2518. The workflow then continues to the annual plan 2520, the rolling 90-day plan 2522, the executive workforce quarterly report part B 2524, and the executive workforce annual report 2526.

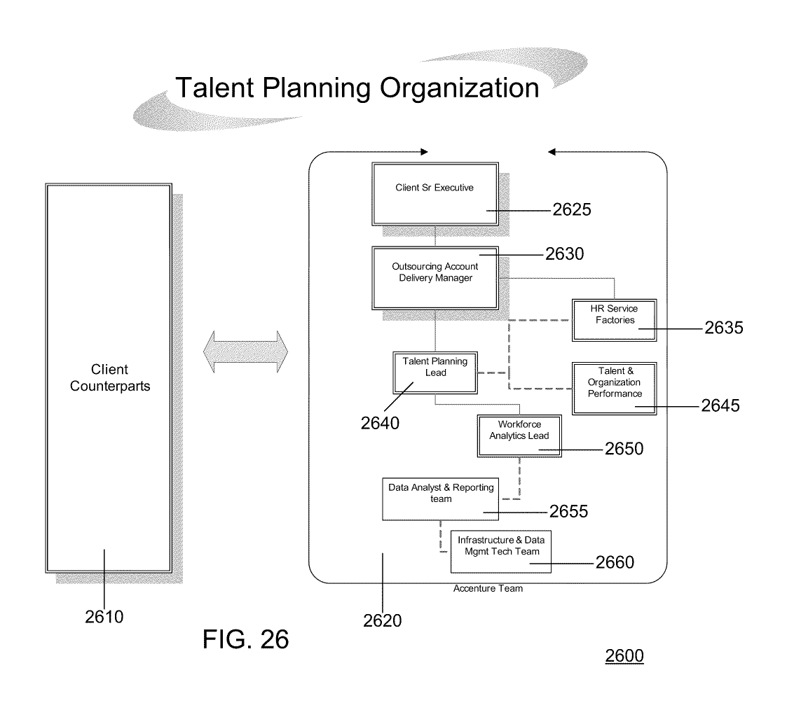

FIG. 26 is a user interface 2600 displaying an alternative talent planning deliverables workflow in the system of FIG. 1, or other systems for providing workforce planning services. The workflow begins with a client strategic objectives summary 2602. The workflow progresses to workforce risk and opportunities 2604 and workforce strategic objective attainment analysis 2606. The workflow then progresses to business cases 2608 and business cases and/or opportunity assessment 2610. The workflow then progresses to the executive quarterly report 2612. The workflow then proceeds to initiatives 2614, such as project A 2616, project B 2618, and project C 2620. The workflow then progresses to the annual plan 2622, followed by the executive workforce quarterly report 2624, and lastly the executive workforce annual report 2626.

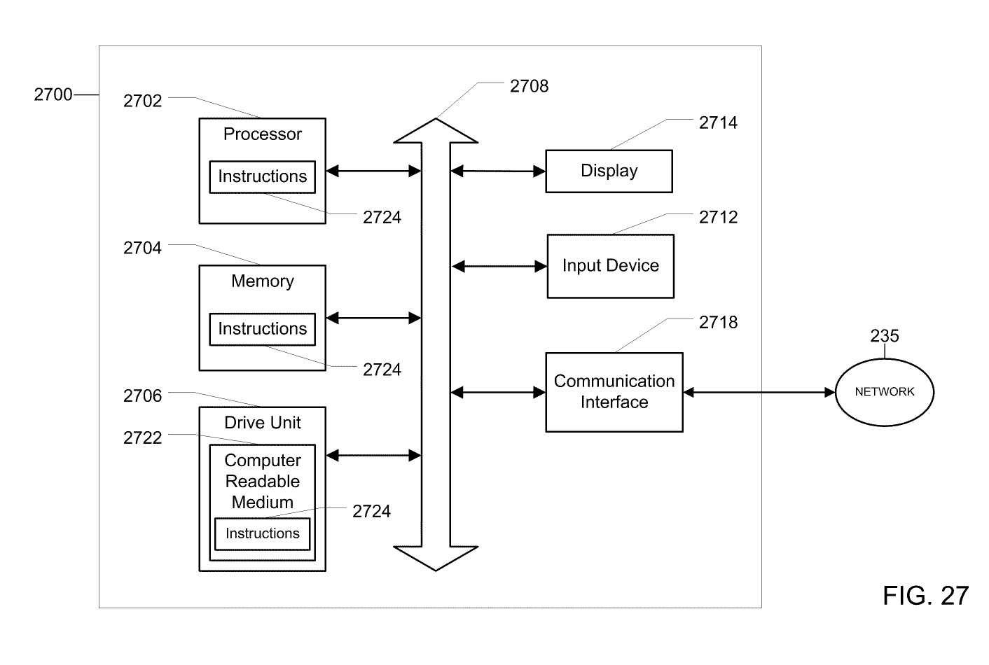

FIG. 27 is a block diagram illustrating a talent planning personnel hierarchy 2700 in the system of FIG. 1, or other systems for providing workforce planning services. The hierarchy 2700 includes client counterparts 2710 and a service provider team 2720. The service provider team 2720 includes a client senior executive 2725, an outsourcing account delivery manager 2730, a talent planning lead 2740, a workforce analytics lead 2750, a data analyst and report team 2755, and an infrastructure and data management tech team 2760. The outsourcing account delivery manager 2730 provides guidance to the service factories 2735 and coordinates with the talent and an organizational performance consulting group 2745.

FIG. 28 illustrates a general computer system 2800, which may represent a service provider server 240, or any of the other computing devices referenced herein. The computer system 2800 may include a set of instructions 2824 that may be executed to cause the computer system 2800 to perform any one or more of the methods or computer based functions disclosed herein. The computer system 2800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 2800 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 2824 (sequential or otherwise) that specify actions to be taken by that machine. In a particular embodiment, the computer system 2800 may be implemented using electronic devices that provide voice, video or data communication. Further, while a single computer system 2800 may be illustrated, the term “system” shall also be taken to include any collection of systems or sub-systems that individually or jointly execute a set, or multiple sets, of instructions to perform one or more computer functions.

As illustrated in FIG. 28, the computer system 2800 may include a processor 2802, such as, a central processing unit (CPU), a graphics processing unit (GPU), or both. The processor 2802 may be a component in a variety of systems. For example, the processor 2802 may be part of a standard personal computer or a workstation. The processor 2802 may be one or more general processors, digital signal processors, application specific integrated circuits, field programmable gate arrays, servers, networks, digital circuits, analog circuits, combinations thereof, or other now known or later developed devices for analyzing and processing data. The processor 2802 may implement a software program, such as code generated manually (i.e., programmed).

The computer system 2800 may include a memory 2804 that can communicate via a bus 2808. The memory 2804 may be a main memory, a static memory, or a dynamic memory. The memory 2804 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 2804 may include a cache or random access memory for the processor 2802. Alternatively or in addition, the memory 2804 may be separate from the processor 2802, such as a cache memory of a processor, the system memory, or other memory. The memory 2804 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 2804 may be operable to store instructions 2824 executable by the processor 2802. The functions, acts or tasks illustrated in the figures or described herein may be performed by the programmed processor 2802 executing the instructions 2824 stored in the memory 2804. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 2800 may further include a display 2814, such as a liquid crystal display (LCD), an organic light emitting diode (OLED), a flat panel display, a solid state display, a cathode ray tube (CRT), a projector, a printer or other now known or later developed display device for outputting determined information. The display 2814 may act as an interface for the user to see the functioning of the processor 2802, or specifically as an interface with the software stored in the memory 2804 or in the drive unit 2806.

Additionally, the computer system 2800 may include an input device 2812 configured to allow a user to interact with any of the components of system 2800. The input device 2812 may be a number pad, a keyboard, or a cursor control device, such as a mouse, or a joystick, touch screen display, remote control or any other device operative to interact with the system 2800.

The computer system 2800 may also include a disk or optical drive unit 2806. The disk drive unit 2806 may include a computer-readable medium 2822 in which one or more sets of instructions 2824, e.g. software, can be embedded. Further, the instructions 2824 may perform one or more of the methods or logic as described herein. The instructions 2824 may reside completely, or at least partially, within the memory 2804 and/or within the processor 2802 during execution by the computer system 2800. The memory 2804 and the processor 2802 also may include computer-readable media as discussed above.

The present disclosure contemplates a computer-readable medium 2822 that includes instructions 2824 or receives and executes instructions 2824 responsive to a propagated signal; so that a device connected to a network 235 may communicate voice, video, audio, images or any other data over the network 235. Further, the instructions 2824 may be transmitted or received over the network 235 via a communication interface 2818. The communication interface 2818 may be a part of the processor 2802 or may be a separate component. The communication interface 2818 may be created in software or may be a physical connection in hardware. The communication interface 2818 may be configured to connect with a network 235, external media, the display 2814, or any other components in system 2800, or combinations thereof. The connection with the network 235 may be a physical connection, such as a wired Ethernet connection or may be established wirelessly as discussed below. Likewise, the additional connections with other components of the system 2800 may be physical connections or may be established wirelessly. In the case of a service provider server 240, the service provider server may communicate with users 120A-N through the communication interface 2818.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 2822 may be a single medium, or the computer-readable medium 2822 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 2822 may include a solid-state memory such as a memory card or other package that houses one or more non-volatile read-only memories. The computer-readable medium 2822 also may be a random access memory or other volatile re-writable memory. Additionally, the computer-readable medium 2822 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for generating a workforce service plan and monitoring implementation thereof, the method comprising:
identifying a baseline workforce dataset, wherein the baseline workforce dataset describes a current plurality of employees of an organization;
determining a projected workforce dataset based on the baseline workforce dataset and a criterion, wherein the projected workforce dataset describes a projected plurality of employees required by the organization over a period of time;
assessing the baseline workforce dataset and a plurality of employee movement strategies to determine a forecasted available workforce dataset, wherein the forecasted available workforce dataset describes a forecasted plurality of employees available to the organization over the period of time;
determining, by a processor, a workforce gap dataset describing a gap between the projected workforce dataset and the forecasted available workforce dataset;
generating a workforce service plan, wherein the workforce service plan describes a plurality of strategies for eliminating the gap described by the workforce gap dataset over the period of time such that the projected workforce dataset equals the forecasted available workforce dataset over the period of time;
providing the workforce service plan to a user;
receiving a plurality of updates to the baseline workforce dataset over the period of time; and
assessing the plurality of updates to the baseline workforce dataset over the period of time to determine whether the workforce service plan is being implemented effectively.

2. The method of claim 1 wherein the criterion comprises at least one of an external market condition or a target growth factor.

3. The method of claim 1 wherein the workforce service plan comprises at least one of a talent acquisition plan, a talent development plan, or a talent retention plan.

4. The method of claim 3 wherein the talent acquisition plan comprises a comparison of a forecasted workforce demand with the workforce dataset.

5. The method of claim 3 wherein the talent development plan describes a workforce gap for each of a plurality of job families of the workforce dataset and a workforce gap for each of a plurality of geographies of the workforce dataset over the period of time.

6. The method of claim 3 wherein the talent retention plan comprises a comparison of a forecasted workforce demand against a historical dataset describing a pattern of retirements, a pattern of terminations and a pattern of transfers.

7. The method of claim 1 wherein the plurality of employee movement strategies comprises at least one of a historical pattern of retirements, a historical pattern of terminations or a historical pattern of transfers.

8. The method of claim 1 further comprising:
generating an annual talent service plan based on the workforce service plan, wherein the annual talent service plan describes monthly goals for achieving the workforce service plan; and
providing the annual talent service plan to the user.

9. The method of providing workforce planning services, the method comprising:
identifying a business strategy of an organization and a business metric, wherein the business strategy describes a plurality of business objectives of the organization and the business metric identifies whether the business objectives are being achieved;
determining a key workforce segment of a plurality of workforce segments, wherein the key workforce segment has a greatest affect on the business metric of any of the plurality of workforce segments;
determining a plurality of roles within the key workforce segment, the plurality of roles required to achieve the plurality of business objectives;
ranking each of the plurality of roles based on an affect each of the plurality of roles has on the business metric and a number of employees within each role;
determining a forecasted number of employees required within each of the plurality of roles over a period of time;
generating, by a processor, a workforce action plan for obtaining the forecasted number of employees for each of the plurality of roles over the period of time, wherein the talent action plan prioritizes obtaining the forecasted number of employees for each of the plurality of roles based on the ranking;
implementing the workforce action plan over the period of time; and
monitoring the implementing of the workforce action plan and the business metric to identify whether the business objectives are being achieved over the period of time.

10. The method of claim 9 wherein the workforce action plan comprises at least one of a workforce acquisition plan, a workforce development plan, or a workforce retention plan.

11. The method of claim 9 further comprising determining the forecasted number of employees required within each of the plurality of roles over the period of time based on an external market condition.

12. The method of claim 9 further comprising determining the forecasted number of employees required within each of the plurality of roles over the period of time based on a target growth factor.

13. The method of claim 9 wherein determining the plurality of roles within the key workforce segment further comprises determining a baseline dataset of the key workforce segment.

14. The method of claim 13 wherein monitoring the implementing of the workforce action plan further comprising monitoring the implementing of the workforce action plan by comparing the baseline dataset with a current workforce dataset over the period of time.

15. A system for generating a workforce service plan and monitoring implementation thereof, the system comprising:
a memory operative to store a baseline workforce dataset describing a current plurality of employees of an organization;
an interface, coupled to the memory, the interface operative to communicate with a device of a user; and
a processor, coupled to the memory and the interface, the processor operative to identify the baseline workforce dataset, determine a projected workforce dataset based on the baseline workforce dataset and a criterion, wherein the projected workforce dataset describes a projected plurality of employees required by the organization over a period of time, assess the baseline workforce dataset and a plurality of employee movement strategies to determine a forecasted available workforce dataset, wherein the forecasted available workforce dataset describes a forecasted plurality of employees available to the organization over the period of time, determine a workforce gap dataset describing a gap between the projected workforce dataset and the forecasted available workforce dataset, generate a workforce service plan, wherein the workforce service plan describes a plurality of strategies for eliminating the gap described by the workforce gap dataset over the period of time, provide, via the interface, the workforce service plan to the device of the user, receive, via the interface, a plurality of updates to the baseline workforce dataset over the period of time, and assess the plurality of updates to the baseline workforce dataset over the period of time to determine whether the workforce service plan is being implemented effectively.

16. The system of claim 15 wherein the criterion comprises at least one of an external market condition or a target growth factor.

17. The system of claim 15 wherein the workforce service plan comprises at least one of a talent acquisition plan, a talent development plan, or a talent retention plan.

18. The system of claim 17 wherein the talent acquisition plan comprises a comparison of a forecasted workforce demand with the workforce dataset.

19. The system of claim 17 wherein the talent development plan describes a workforce gap for each of a plurality of job families of the workforce dataset and a workforce gap for each of a plurality of geographies of the workforce dataset over the period of time.

20. The system of claim 17 wherein the talent retention plan comprises a comparison of a forecasted workforce demand against a historical dataset describing a pattern of retirements, a pattern of terminations and a pattern of transfers.

21. The system of claim 15 wherein the plurality of employee movement strategies comprises at least one of a historical pattern of retirements, a historical pattern of terminations or a historical pattern of transfers.

22. The system of claim 15 wherein the processor is further operative to generate an annual talent service plan based on the workforce service plan, wherein the annual talent service plan describes monthly goals for achieving the workforce service plan and provide, via the interface, the annual talent service plan to the device of the user.
